(19) United States
(12) Patent Application Publication
(10) Pub. No.: US 2005/0259361 A1
(43) Pub. Date: Nov. 24, 2005

(54) Magnetic disk cartidge

(75) Inventors: Harumi Aoishi, Kanagawa-ken (JP); Fumihito Imai, Kanagawa-ken (JP); Hideaki Shiga, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/190,861

(22) Filed: Jul. 28, 2005

Related U.S. Application Data
(62) Division of application No. 10/436,190, filed on May 13, 2003.

(30) Foreign Application Priority Data
Jan. 23, 2003 (JP) 014823/2003
May 13, 2002 (JP) 137134/2002
Sep. 27, 2002 (JP) 282398/2002
Nov. 15, 2002 (JP) 332319/2002

(51) Int. Cl. G11B 23/03

(52) U.S. Cl. 360/133

(57) ABSTRACT

A magnetic disk cartridge including a flexible magnetic disk, a hub, disk-holding protrusions, and an anti slip-out member. The hub has a disk-holding surface on which the central portion of the magnetic disk is held. The disk-holding protrusions are formed on the disk-holding surface of the hub, and are inserted through holes formed in the magnetic disk. The anti slip-out member is used to prevent the magnetic disk from slipping out from the disk-holding protrusions.

### BACKGROUND OF THE INVENTION

1. Field of the Invention

The present invention relates to magnetic disk cartridges, and more particularly to a structure in which a flexible magnetic disk is firmly held to a hub.

2. Description of the Related Art

In conventional magnetic disk cartridges, a flexible magnetic disk includes a support formed from a flexible polyester sheet, a polyethylene terephthalate (PET) sheet, etc., and magnetic layers formed on both sides of the support. The magnetic disk is rotatably housed in a casing. The casing includes an upper shell with an upper head slot and a lower shell with a lower head slot.

The magnetic disk cartridge of this kind is used primarily as a recording medium for computers or a recording medium for digital cameras, because it is easy to handle and low-cost.

FIG. 26 shows a small magnetic disk cartridge called “clik!′ (R)” that is described, for example, in U.S. Pat. No. 6,256,168. The central portion of a flexible magnetic disk 2 of diameter 1.8 in (about 46 mm) is firmly supported by a hub 3. The hub 3 includes a circular plate portion 3b with a flat top surface 3a, and a small-diameter engagement portion 3d protruding from the bottom surface of the plate portion 3b. When the magnetic disk cartridge is inserted in a disk drive unit, a drive spindle 6 magnetically attracts the engagement portion 3d by a magnet 7 mounted on the drive spindle 6 and spins the magnetic disk at a predetermined speed.

In the magnetic disk cartridge, the magnetic disk 2 is firmly held on the top surface 3a of the circular plate portion 3b of the hub 3 by employing an adhesive double-coated tape 4, an adhesive, etc. The adhesive double-coated tape 4 refers to tape with adhesive layers on both sides of a flexible supporting sheet, tape consisting of only adhesive-impregnated layers without a substrate, and so forth.

However, in the above-described conventional magnetic disk cartridge, residual stress during adhesion causes wrinkles and strain to occur in that portion of the magnetic disk 2 fixed to the hub, and sometime have influence on the surrounding portion or outer periphery of the magnetic disk 2 as well. Particularly, as magnetic disks are reduced in diameter and increased incapacity, the distance between the innermost circumference of the recording area of the magnetic disk 2 and the outer circumference of the hub 3 becomes shorter, and consequently, degradation in flatness and storage characteristics due to the above-described wrinkles and strain has an adverse effect on the recording area of the magnetic disk 2.

### SUMMARY OF THE INVENTION

The present invention has been made in view of the problems found in prior art. Accordingly, it is the object of the present invention to provide a magnetic disk cartridge that is capable of obtaining stable characteristics by preventing deformation of the magnetic disk which is caused as the magnetic disk is fixed to a hub or which is caused by the influence of material.

As a first means for achieving the above-described object of the present invention, there is provided a magnetic disk cartridge comprising a flexible magnetic disk, a hub, disk-holding protrusions, and anti slip-out means. The hub has a disk-holding surface on which the central portion of the magnetic disk is held. The disk-holding protrusions are formed on the disk-holding surface of the hub, and are inserted through guide holes formed in the magnetic disk. The anti slip-out means is used to prevent the magnetic disk from slipping out from the disk-holding protrusions.

In this case, the aforementioned disk-holding protrusions are preferably provided symmetrically with respect to the center of rotation of the hub.

The aforementioned anti slip-out means can be constructed by caulking the tip end of the disk-holding protrusion like a rivet to form a diameter-enlarged portion, or it can be constructed by mounting a plate member larger in diameter than the guide holes of the magnetic disk on the tip end of the disk-holding protrusion.

It is preferable that the guide holes of the magnetic disk be made slightly larger than the outside diameter of the disk-holding protrusion of the hub to provide clearance between the two.

The aforementioned anti slip-out means may be constructed by forming a center hole in a magnetic disk, providing a protrusion, which is inserted through the center hole of the magnetic disk, on the disk-holding surface of a hub, and caulking or bending the tip end of the protrusion to form a diameter-enlarged portion.

In addition, a magnetic disk may be held on the disk-holding surface of the hub by forming a center hole in the magnet disk and inserting a separate anti slip-out member with a diameter-enlarged portion into the center hole.

To minimize a contact area between the hub and the magnetic disk, a plurality of disk-holding projections (e.g., 3 projections) for holding the magnetic disk at their ends, in addition to the aforementioned disk-holding protrusions, may be provided on the disk-holding surface of the hub. The anti slip-out means in this case, as described above, may be constructed by enlarging the tip end of the disk-holding projection, but it can also be constructed by a press plate which is pressed against the surface, opposite to the hub side, of the magnetic disk, and an elastic member interposed between this press plate and the casing. Furthermore, the above-described anti slip-out means may include other various forms.

As a second means for achieving the above-described object of the present invention, there is provided a magnetic disk cartridge comprising a flexible magnetic disk, a hub, and an adhesive double-coated tape. The flexible magnetic disk has a flexible support, and magnetic layers formed on both sides of the flexible support. The hub has a disk-holding surface on which the central portion of the magnetic disk is held. The adhesive double-coated tape has a flexible substrate whose thermal expansion coefficient is approximate to that of the flexible support of the magnetic disk, and adhesive layers formed on both sides of the flexible substrate of the tape. In the magnetic disk cartridge constructed as described above, the magnetic disk is firmly held on the disk-holding surface of the hub through the adhesive double-coated tape.

In this case, the approximate thermal expansion coefficient means that a deviation in thermal expansion coefficient between the support of the magnetic disk and the substrate of the adhesive double coated tape is within a range of ±2×10⁻⁵/° C., preferably ±1×10⁻⁵/° C. In the best case, the two substrates are formed from polyethylene terephthalate (PET) resin and a deviation in thermal expansion coefficient is nearly zero.

In addition, it is preferable that the adhesive layer of the adhesive double-coated tape be thinner.

As a third means for achieving the above-described object of the present invention, there is provided a magnetic disk cartridge comprising a flexible magnetic disk, a hub, and a disk-clamping member. The flexible magnetic disk has a center hole, and the hub is equipped with a center hole, and a disk-holding surface on which the central portion of the magnetic disk is held. The disk-clamping member has a cylindrical portion which is fitted in the center hole of the hub through the center hole of the magnetic disk, and a flange portion. The flange portion is formed in one end of the cylindrical portion, and has a disk press surface that mechanically holds the magnetic disk on the disk-holding surface of the hub.

In this case, it is preferable that the outer periphery of the cylindrical portion of the disk-clamping member be provided with recesses that are filled with an adhesive before insertion to the center hole of the hub.

Preferably, the hub is formed from a soft magnetic material such as an iron material that can be attracted to a spindle of a disk drive unit by a magnet mounted on the spindle when the magnetic disk cartridge is inserted in the disk drive unit, and the disk-clamping member is formed from a soft magnetic material that can be attracted to the disk-holding surface of the hub through the magnetic disk as the hub is attracted to the drive spindle.

In addition, it is preferable that the disk press surface of the flange portion have a friction sheet that prevents the magnetic disk from slipping on the flange portion.

Furthermore, there may be interposed an elastic body between the disk press surface of the flange portion and the magnetic disk.

As a fourth means for achieving the above-described object of the present invention, there is provided a magnetic disk cartridge comprising a flexible magnetic disk, a hub, friction means, and a disk anti slip-out member. The flexible magnetic disk has a center hole, and the hub is equipped with a center hole, and a disk-holding surface on which the central portion of the magnetic disk is held. The friction means is provided on the disk-holding surface of the hub, and the magnetic disk is held on the hub through the friction means. The disk anti slip-out member has a cylindrical portion which is fitted in the center hole of the hub through the center hole of the magnetic disk, and a flange portion formed in one end of the cylindrical portion.

Preferably, there is a predetermined clearance between is the magnetic disk and the surface, facing the magnetic disk, of the flange portion of the disk anti slip-out member. In that case, it is preferable that the wall of the center hole of the hub be provided with a step portion that prescribes an insertion depth of the cylindrical portion of the disk anti slip-out member relative to the center hole of the hub.

The above-described friction means can be constructed by a friction sheet mounted on the disk-holding surface of the hub. It can also be formed by a surface treatment in which the friction coefficient of the disk-holding surface of the hub is enhanced. Furthermore, the friction means may include other various forms.

In a preferred form of the magnetic disk cartridge as the fourth means, the hub is formed from a soft magnetic material such as an iron material that can be attracted to a spindle of a disk drive unit by a magnet mounted on the spindle when the magnetic disk cartridge is inserted in the disk drive unit, and the disk anti slip-out member is formed from a soft magnetic material that can be attracted to the hub as the hub is attracted to the drive spindle.

As a fifth means for achieving the above-described object of the present invention, there is provided a magnetic disk cartridge comprising a flexible magnetic disk, a hub, and a disk anti slip-out member. The flexible magnetic disk has a center hole, and the hub is equipped with a center hole, and a disk-holding surface on which the central portion of the magnetic disk is held. The disk anti slip-out member includes a cylindrical portion which is fitted in the center hole of the hub through the center hole of the magnetic disk, and a flange portion formed in one end of the cylindrical portion. The surface, facing the magnetic disk, of the flange portion of the disk anti slip-out member is provided with disk-clamping protrusions that are fitted in holes formed in the disk-holding surface of the hub through holes formed in the magnetic disk.

In the magnetic disk cartridge as the fifth means, the wall of the center hole of the hub preferably is provided with a step portion that prescribes an insertion depth of the cylindrical portion of the disk anti slip-out member relative to the center hole of the hub.

In the first invention, the disk-holding protrusions of the hub are inserted through the guide holes of the magnetic disk, and limit the movement of the magnetic disk in the direction of rotation. Therefore, unlike the case where the magnetic disk is fixed to the hub by adhesion, there is no possibility that wrinkles and strain will occur in the magnetic disk by residual stress produced when both are fixed together, and consequently, stable disk characteristics are obtained.

And since the magnetic disk cartridge is equipped with the anti slip-out means, there is no possibility that the magnetic disk will slip out from the disk-holding protrusions.

In the case where the guide holes of the magnetic disk are made slightly larger than the outside diameter of the disk-holding protrusion of the hub to provide clearance between the two, residual stress is removed in the clearance provided in the non-recording area of the hub, even if the stress is exerted on the magnetic disk. Thus, the recording area of the magnetic disk is able to avoid undergoing stress.

In the case where a plurality of disk-holding projections (e.g., 3 projections) for holding the magnetic disk at their ends, in addition to the aforementioned disk-holding protrusions, are provided on the disk-holding surface of the hub, the magnetic disk is held in point-contact with the 3 disk-holding projections of the hub, so more stable disk characteristics are obtained.

In the second invention, the magnetic disk is firmly held on the disk-holding surface of the hub through the adhesive double-coated tape, which has a flexible substrate whose thermal expansion coefficient is approximate to that of the flexible support of the magnetic disk. Therefore, even when the ambient temperature changes, the substrate of the magnetic disk is deformed the same as the substrate of the adhesive double-coated tape, so they are less liable to undergo strain.

Because the thermal expansion coefficient of the adhesive layer in the adhesive double-coated tape generally differs from that of the substrate, the adhesive layer should be made as thin as possible. In this way, the occurrence of wrinkles and strain can be more effectively minimized.

In general, the adhesive double-coated tape is first attached to the magnetic disk, and then it is attached to the hub. In this case, the adhesive double-coated tape with a substrate is used, so it becomes firmer and can be attached readily to the magnetic disk.

In the third invention, a magnetic disk cartridge comprises a flexible magnetic disk, a hub, and a disk-clamping member. The flexible magnetic disk has a center hole, and the hub is equipped with a center hole, and a disk-holding surface on which the central portion of the magnetic disk is held. The disk-clamping member has a cylindrical portion which is fitted in the center hole of the hub through the center hole of the magnetic disk, and a flange portion. The flange portion is formed in one end of the cylindrical portion, and has a disk press surface that mechanically holds the magnetic disk on the disk-holding surface of the hub. Therefore, unlike the case where the magnetic disk is fixed to the hub by adhesion, there is no possibility that wrinkles and strain will occur in the magnetic disk by residual stress produced when both are fixed together, and consequently, stable disk characteristics are obtained.

In addition, there is an advantage that conventional magnetic disks can be utilized as they are. That is, projections and holes for preventing rotation of the magnetic disk do not have to be provided in the hub and the magnetic disk. Because there is no projection on the disk-holding surface of the hub, the flatness of the disk-holding surface can be easily obtained in manufacturing the hub. In addition, the management of the accuracy of the form and position of projections and holes becomes unnecessary, and furthermore, the alignment between projections and holes becomes unnecessary at the time of assembling, so assembling is easy.

In that case, if the outer periphery of the cylindrical portion of the disk-clamping member is provided with recesses that are filled with an adhesive before insertion to the center hole of the hub, the magnetic disk is pressed against the disk-holding surface of the hub by the press surface of the flange portion of the disk-clamping member, and in this state, the disk-clamping member can be fixed to the hub. The adhesive in this case can be held without contacting the magnetic disk, so there is no possibility that it will have detrimental effects on the characteristics of the magnetic disk.

If the hub is formed from an iron material that can be attracted to a spindle of a disk drive unit by a magnet mounted on the spindle, and the disk-clamping member is formed from the same material, the disk-clamping member is attracted to the disk-holding surface of the hub through the magnetic disk as the hub is attracted to the drive spindle, and the magnetic disk is firmly held. Thus, a means of fixing the disk-clamping member to the hub becomes unnecessary.

In the case where the holding of the magnetic disk by the disk-clamping member is insufficient and therefore relative rotation occurs between the disk-clamping member and the magnetic disk, the relative rotation can be prevented by attaching a friction sheet to the disk press surface of the flange portion of the disk-clamping member.

In the case where there is interposed an elastic body between the disk press surface of the flange portion and the magnetic disk, irregularities on the disk press surface can be absorbed by the elastic body, so when the disk-clamping member is pressed against the magnetic disk, irregularities on the disk press surface have little influence on the characteristics of the magnetic disk.

In the fourth invention, a magnetic disk cartridge comprises a flexible magnetic disk, a hub, friction means, and a disk anti slip-out member. The flexible magnetic disk has a center hole, and the hub is equipped with a center hole, and a disk-holding surface on which the central portion of the magnetic disk is held. The friction means is provided on the disk-holding surface of the hub, and the magnetic disk is held on the hub through the friction means. The disk anti slip-out member has a cylindrical portion that is fitted in the center hole of the hub through the center hole of the magnetic disk, and a flange portion formed in one end of the cylindrical portion. Therefore, as with the above-described third invention, projections and holes for preventing rotation of the magnetic disk do not have to be provided in the hub and the magnetic disk. Therefore, the management of the accuracy of the form and position of projections and holes becomes unnecessary, and furthermore, the alignment between projections and holes becomes unnecessary at the time of assembling, so assembling is easy.

In the case where there is a predetermined clearance between the magnetic disk and the surface, facing the magnetic disk, of the flange portion of the disk anti slip-out member, there is no possibility that a force of pressing the magnetic disk against the hub will be exerted on the magnetic disk. This can minimize the occurrence of residual stress in the magnetic disk.

And if the wall of the center hole of the hub is provided with a step portion that prescribes an insertion depth of the cylindrical portion of the disk anti slip-out member relative to the center hole of the hub, the above-described clearance can be easily provided between the magnetic disk and the surface, facing the magnetic disk, of the flange portion of the disk anti slip-out member.

In the case of the present invention, if the drive spindle of the disk drive unit begins to rotate, torque is transmitted to the hub, and the hub begins to rotate. Since the friction sheet is mounted on the disk-holding surface of the hub, friction force is produced between the surface of the friction sheet and the surface of the magnetic disk, the magnetic disk is firmly held on the friction sheet. Therefore, even if clearance is present between the bottom surface of the flange portion of the disk anti slip-out member and the magnetic disk, the clearance has no influence on read and write operations.

In addition, in the case where the hub is formed from an iron material that can be attracted to a spindle of a disk drive unit by a magnet mounted on the spindle, and the disk-clamping member is formed from the same material, the disk-clamping member is attracted to the hub as the hub is attracted to the drive spindle. Thus, there is an advantage that a means of fixing the disk-clamping member to the hub becomes unnecessary.

In the fifth invention, the disk anti slip-out member includes a cylindrical portion that is fitted in the center hole of the hub through the center hole of the magnetic disk, and a flange portion formed in one end of the cylindrical portion. The surface, facing the magnetic disk, of the flange portion of the disk anti slip-out member is provided with disk-clamping protrusions that are fitted in holes formed in the disk-holding surface of the hub through holes formed in the magnetic disk. Therefore, as with the first invention, the fifth invention can prevent the magnetic disk from rotating with respect to the hub, while minimizing the occurrence of residual stress in the magnetic disk. Furthermore, since there is no projection on the disk-holding surface of the hub that contacts the magnetic disk, flatness is readily obtained in manufacturing the hub.

If the wall of the center hole of the hub is provided with a step portion that prescribes an insertion depth of the cylindrical portion of the disk anti slip-out member relative to the center hole of the hub, the flange portion of the disk anti slip-out member can be held without contacting the magnetic disk.

### BRIEF DESCRIPTION OF THE DRAWINGS

The present invention will be described in further detail with reference to the accompanying drawings wherein:

FIG. 1 is a sectional view showing the rotating body of a magnetic disk cartridge constructed in accordance with a first embodiment of a first invention;

FIG. 2 is an exploded perspective view of the rotating body shown in FIG. 1;

FIG. 3 is an enlarged sectional view of the principal part of the rotating body shown in FIG. 1;

FIGS. 4A and 4B are sectional views showing a rotating body constructed in accordance with a second embodiment of the first invention;

FIGS. 5A, 5B, and 5C are sectional views showing a rotating body constructed in accordance with a third embodiment of the first invention;

FIG. 6A is a perspective view showing a hub constructed in accordance with a fourth embodiment of the first invention;

FIG. 6B is a plan view of the hub shown in FIG. 6A;

FIG. 7 is a sectional view of the principal part of a magnetic disk cartridge with the hub shown in FIG. 6;

FIGS. 8A and 8B are enlarged sectional views showing a magnetic disk cartridge constructed in accordance with a second invention;

FIG. 9 is a sectional view showing the rotating body of a magnetic disk cartridge constructed in accordance with a third invention;

FIG. 10 is an exploded sectional view of the rotating body shown in FIG. 9;

FIG. 11A is an enlarged sectional view showing a variation of the disk-clamping member of FIG. 10;

FIG. 11B is an enlarged bottom view of the disk-clamping member of FIG. 11A;

FIG. 12 is a sectional view of a rotating body with the disk-clamping member of FIG. 11;

FIG. 13 is a sectional view showing the relative positional relationship between the rotating body of FIG. 9 and other members within the magnetic disk cartridge;

FIG. 14 is a sectional view of the disk-clamping member of FIG. 10 with a friction sheet mounted on a disk press surface;

FIGS. 15A, 15B, and 15C are bottom views showing three forms of friction sheets mounted on the disk-clamping member;

FIG. 16 is an enlarged sectional view showing the state in which an elastic member is interposed between the disk press surface of a disk-clamping member and a magnetic disk;

FIG. 17 is a sectional view showing the rotating body of a magnetic disk cartridge constructed in accordance with a fourth invention;

FIG. 18 is an exploded sectional view of the rotating body shown in FIG. 17;

FIG. 19 is an enlarged sectional view showing the stacked structure of a friction sheet;

FIG. 20 is a sectional view showing the relative positional relationship between the rotating body of FIG. 17 and other members within the magnetic disk cartridge;

FIGS. 21A, 21B, and 21C are plan views showing three forms of friction sheets mounted on the disk-clamping member;

FIG. 22 is a sectional view showing a variation of the rotating body of FIG. 17;

FIG. 23 is a sectional view showing the rotating body of a magnetic disk cartridge constructed in accordance with a fifth invention;

FIG. 24 is a bottom view of the anti slip-out member shown in FIG. 23;

FIG. 25 is a sectional view showing a variation of the rotating body of FIG. 23; and

FIG. 26 is a sectional view showing the state of engagement between the hub of a conventional magnetic disk cartridge and the drive spindle of a cartridge drive unit.

### DESCRIPTION OF THE PREFERRED EMBODIMENTS

Initially, the basic construction of a magnetic disk cartridge to which the present invention is applied will be described in detail.
1) Formal Characteristic:
   Small floppy disk such as the aforementioned “clik! (R)” of diameter 50.8 mm (about 2 in) or less removable from a drive unit
2) Storage Capacity and Recording Density:
   1 GB or greater, and 0.47 Gbit/cm² (3 Gbit/in²) or greater
3) Magnetic Material:
   Barium ferrite (BaFe)
4) Track Writing Method at the Time of Manufacture:
   Magnetic transfer
5) Magnetic Head in a Drive Unit:
   MR head
6) Tracks:
   1-μm tracking
7) Uses:
   Personal computers, moving-picture cameras, and still-picture cameras having a PCMCIA card drive

Next, a description will be given of media that are applied to the magnetic disk cartridge of the present invention.

For a magnetic disk medium with a capacity of a few hundred megabits or greater to be small, the recording density must be considerably enhanced. An MR head for high-sensitive reproduction makes it possible to obtain a sufficient output signal even with narrow tracks and high line recording density, but since noise in the medium is also amplified, a sufficient SN ratio cannot be obtained with conventional media whose noise is great and therefore an enhancement in the recording density cannot be achieved. It has been found that in a magnetic disk provided in this order with a practically non-magnetic layer (underlying layer), and a magnetic layer having ferromagnetic hexagonal ferrite powder dispersed in a binder, the use of an MR head can achieve less noise and a high SN ratio if hexagonal ferrite is used as a magnetic substance for that magnetic layer. Although the details of hexagonal ferrite will be described later, it is particularly necessary to employ an average plate size of 35 nm or less and perform a sufficient dispersion process. This makes it possible for a magnetic disk of outside diameter 45 mm to achieve a SN ratio required for recording of capacity 1 GB or greater, and it has been found that a recording medium for computer equipment and video equipment that is the object of the present invention can be realized.

Preferred Forms

The disk outside diameter is between 20 mm and 50 mm. If it exceeds 50 mm, application to a PCMCIA slot becomes difficult. If it is less than 20 mm, a capacity of a few hundred megabits cannot be achieved.

The disk inside diameter is not particularly limited, but it is typically between 2 mm and 10 mm. If it is less than 2 mm, it becomes difficult to chuck the disk at high speeds with a spindle. If it exceeds 10 mm, a recording area is reduced.

It is preferable that the amount of the surface tilt of the outer circumference be 30 μm or less and further preferable that it be 20 μm or less. The lower limit is not particularly limited, but it is typically 5 μm or greater.

It is preferable that the amount of the surface tilt of the inner circumference be 15 μm or less and further preferable that it be 10 μm or less. The lower limit is not particularly limited, but it is typically 5 μg/m or greater.

In a state without a cartridge, the surface tilt typically increases from a certain state, but it is preferable that even in a state without a cartridge, it be 50 μm or less. When a read/write head is pressed against a disk or loaded, the surface tilt is typically reduced, and a medium that is applied to the magnetic disk cartridge of the present invention is typically 30 μm or less.

Preferably, the maximum displacement does not change greatly as a disk rotates, and the phase does not change. In such a case, it will become difficult to perform tracking servo.

The displacement of the surface tilt usually has several degree components in one round of the track. In this case, it is preferable to have a fewer high-degree (third-degree) surface tilt components. If a surface tilt of high order is great, a change in displacement relative to angle will become greater and it will become difficult to perform tracking servo.

The rotational speed is preferably between 2000 rpm and 8000 rpm. If it is less than 2000 rpm, centrifugal force on the disk is small and stable rotation cannot be obtained, resulting in a great surface tilt. If it is greater than 8000 rpm, centrifugal force is too great and stable rotation cannot be obtained, resulting in a great surface tilt.

It is preferable that for a medium to be applied to the magnetic disk cartridge of the present invention, the rate of change in dimension be 0.05% or less when it is stored at 60° C. There are cases where this medium is used in portable recording systems, but it is often used outdoors and therefore it is required to be stable with respect to temperature and humidity changes. It has been found that if a change in dimension at normal temperature (23° C.) is 0.05% or less (preferably 0.02% or less) before and after the medium has been stored for one week at 23° C., stable tracking is obtained in a wide environment even at a high recording density at which this medium is used.

Because the information recording area of this medium includes narrow tracks, it is necessary to accurately scan the narrow track width with a read/write head and perform read and write operations at a high S/N ratio, and accurate scanning is performed with a tracking servo technique. In this technique, a tracking servo signal, an address information signal, a clock signal for reproduction, etc., are preformatted at predetermined intervals in one round of a disk. A read/write head accurately tracks the track center by reading out these preformatted signals and correcting its self-position.

The pre-formatting method is disclosed, for example, in Japanese Unexamined Patent Publication No. 63 (1988)-183623 and U.S. Pat. No. 6,347,016. The surface of a substrate is provided with a microscopic “land/groove” pattern corresponding to an information signal. The surface of a master carrier is equipped with a ferromagnetic thin film formed on at least the lands of the land/groove pattern. By bringing the master carrier into contact with the surface of a magnetic recording sheet, or by further applying an AC bias magnetic field or a DC magnetic field and exciting the ferromagnetic material of the land portions, a magnetization pattern corresponding to the land/groove pattern is magnetically transferred to the magnetic recording medium.

In this method, the lands of a land/groove pattern formed in the master carrier are brought into intimate contact with a magnetic recording medium (slave medium) to be preformatted, and at the same time, the ferromagnetic material constituting the lands is excited. In this way, a predetermined format is formed in the slave medium. Because magnetic recording can be performed statically without changing the relative position between the master carrier and the slave medium, accurate pre-formatting can be performed and the time required for pre-formatting is extremely short. That is, in the conventional recording method that uses a read/write head, a few minutes to a few ten minutes are required and the time required for transfer becomes longer in proportional to recording capacity. In contrast, this magnetic transfer method can complete transfer in 1 second or less independently of recording capacity and recording density.

The amount of a surface tilt will be achieved as follows.

If the curl of a disk is reduced to 2 mm or less, the amount of a surface tilt is reduced. The disk curl can be effectively reduced by controlling the time during which a sheet is stored in a rolled state before disks are stamped out from the sheet. If the flatness of a disk is enhanced, the disk tilt amount can be reduced, but it is necessary to reduce a fluctuation in the thickness of the support or coated film to 10% or less. It is necessary to remove microscopic dents and strain from a disk. Small deformation causes a surface tilt of high order and makes tracking servo difficult. The thickness of the medium of the present invention is between 20 μm and 100 μm, and optimum thickness is selected depending upon the rotational speed of a disk. If it is thinner than 20 μm, the rotation of a disk becomes unstable particularly in a high-rotation area and the amount of a surface tilt becomes greater. If it is thicker than 100 μm, disk rotation becomes unstable due to strong centrifugal force and a surface tilt tends to become great in a low-rotation area.

Description of Hexagonal Ferrite Powder

Hexagonal ferrite in the uppermost layer includes substitution products of barium ferrite, strontium ferrite, lead ferrite, and calcium ferrite, Co substitution products, etc. Typical examples are magneto plum-bite type barium ferrite and strontium ferrite, magneto plum-bite type ferrite having particle surfaces coated with spinel, magneto plum-bite type barium ferrite and strontium containing a spinel phase partially, etc. The hexagonal ferrite, in addition to predetermined atoms, may contain atoms such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, etc. Generally, the hexagonal ferrite may contain elements such as Co—Ti, Co—Ti—Zr, Co—Ti—Zn, Ni—Ti—Zn, Nb—Zn—Co, Sb—Zn—Co, Nb—Zn, etc. It may also contain specific impurities depending on the material and generation method used.

The powder size is 10 to 35 nm in hexagonal plate size, and it is preferably 15 to 25 nm. If it is less than 10 nm, stable magnetization is not obtained due to a fluctuation in heat. If it is greater than 35 nm, it increases noise and is unsuitable for high-density magnetic recording that is the object of the present invention. The plate ratio (plate size/plate thickness) is 2 to 6, preferably 2.5 to 3.5. If the plate ratio is small, a fill amount in a magnetic layer is increased, but sufficient orientation is not obtained. If it is greater than 6, stacking between particles increases noise. The specific surface area in this particle size range by a BET method is 30 to 100 m²/g. In most cases, the specific surface area match with a value calculated from particle plate size and plate thickness. A distribution of particle plate sizes and plate thickness is generally preferred if it is narrower. The distribution is difficult to express numerically, but it can be compared by randomly measuring 500 particles with a transmission electron microscope (TEM). In most cases, the distribution is not a normal one, but if it is calculated and expressed in a standard deviation relative to an average size, a ratio of σ/average size is 0.1 to 2.0. To make the particle size distribution sharp, a particle generation reaction system is made as uniform as possible, and generated particles undergo a distribution improvement process. For example, there is a method of selectively dissolving very fine particles in an acid solution. A coercive field Hc that is measured in a magnetic substance is preferably 120×10³ A/m to 320×10³ A/m (1500 Oe to 4000 Oe). Hc is advantageous in high-density recording if it is higher, but it is limited by the capability of a read/write head. Hc can be controlled by particle size (plate size, plate thickness), the kind and amount of elements contained, a replacement site for an element, particle generation reaction conditions, etc. The saturation magnetization σ s is 40 to 60 (Wb·m)/kg (40 to 60 emu/g). A higher saturation magnetization σ s is preferred, but it tends to become smaller if particles become smaller. In dispersing a magnetic substance, the surface of magnetic particles is also treated with a substance that agrees with a dispersing medium and polymers. The surface treating material uses an inorganic compound and an organic compound. Typical examples are an oxide or carbonate with Si, Al, P, etc., various silane coupling agents, and titan coupling agents. The quantity is 0.1 to 10% of a magnetic substance. A pH for a magnetic substance is vital for dispersion. At about 4 to 12, there is an optimum value, depending on dispersing media and polymers, but about 6 to 10 is selected from the viewpoint of the chemical stability and storage of a medium. The moisture in a magnetic substance also has influence on dispersion. Depending on dispersing media and polymers, there is an optimum value, but 0.01 to 2.0% is typically selected.

Hexagonal ferrite is generated by the following methods:

1) Glass Crystallization

Barium oxide, an iron oxide, and a metal oxide replacing iron are mixed as glass-forming substances so that boron oxide, etc., have a desired ferrite composition, and then the mixture is molten and is formed into a non-crystal substance by rapid cooling. After it is heated again, it is washed and reduced to barium ferrite crystal powder.

2) Hydrothermal Reaction

A barium ferrite composition metal salt solution is neutralized with alkali. After secondary products are removed, the neutralized substance is liquid-phase heated at 100° C. or greater. Then, it is washed, dried, and reduced to barium ferrite crystal powder.

3) Coprecipitation

A barium ferrite composition metal salt solution is neutralized with alkali. After secondary products are removed, the neutralized substance is dried and treated at 1100° C. or less. Then, it is reduced to barium ferrite crystal powder.

Description of a Non-Magnetic Layer

In the case of employing an underlying layer, contents related to that layer will be described in detail. Inorganic powder to be employed in this underlying layer is non-magnetic powder. It can be selected from among inorganic compounds such as a metallic oxide, a metallic carbonate, a metallic sulfate, a metallic nitride, a metallic carbide, a metallic sulfide, etc. Examples of inorganic compounds are α-alumina of α-ratio 90% or greater, β-alumina, γ-alumina, θ-alumina, silicon carbide, chromium oxide, α-iron oxide, corundum, silicon nitride, silicon carbide, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfate, and so forth. These are used singly or in combination. Among them, titanium dioxide, zinc oxide, iron oxide, and barium sulfate are preferred, because they have narrow particle distribution and many means of applying a function. Titanium dioxide and α-iron oxide are further preferable. The particle size of these non-magnetic powders is preferably 0.005 to 2 μm. However, if non-magnetic powders different in particle size are combined as occasion demands, or particle distribution is widened with single non-magnetic powder, the same effects can be obtained. The particle size of non-magnetic powder is further preferably 0.01 to 0.2 μm. Particularly, in the case where non-magnetic powder is a powder metallic oxide, the average particle size is preferably 0.08 μm or less, and in the case where it is a needle metallic oxide, the major axis length is preferably 0.03 μm or less. The tap density is 0.05 to 2 g/ml, preferably 0.2 to 1.5 g/ml. The percentage of water content is 0.1 to 5 wt %, preferably 0.2 to 3 wt %, and further preferably 0.3 to 1.5 wt %. The pH of non-magnetic powder is 2 to 11, preferably 5.5 to 10. The specific surface area of non-magnetic powder is 1 to 100 m²/g, preferably 5 to 80 m²/g, and further preferably 10 to 70 m²/g. The crystal size of non-magnetic powder is preferably 0.004 to 1 μm and further preferably 0.04 to 0.1 μm. The DBP oil absorption is 5 to 10 ml/100 g, preferably 10 to 80 ml/100 g, and further preferably 20 to 60 ml/100 g. The specific gravity is 1 to 12, preferably 3 to 6. The non-magnetic powder that is employed in the present invention may be in the form of a needle, a sphere, a polygonal or a plate. The Moh's hardness is preferably 4 to 10. The sodium stearate (SA) absorption of non-magnetic power is 1 to 20 μmol/m², preferably 2 to 15 μmol/m², and further preferably 3 to 8 μmol/m². The pH is preferably 3 to 6.

It is preferable that these non-magnetic powders be surface-treated with Al₂O₃, SiO₂, TiO₂, ZrO₂, SO₂, Sb₂O₃, ZnO, and Y₂O₃. For dispersibility, Al₂O₃, SiO₂, TiO₂, ZrO₂, and SO₂ are preferably, and Al₂O₃, SiO₂, and ZrO₂ are further preferable. These may be employed singly or in combination. In addition, a surface-treated layer by coprecipitation may be employed, depending on purposes, and non-magnetic powder is first treated with alumina and then the surface layer is treated with silica, or it may be treated in reversed order. A surface-treated layer may be made into a porous layer, depending on purposes, but it is generally preferable that it be homogeneous and dense. The quantity of non-magnetic powder to be surface-treated is optimized by the binder used and dispersion conditions.

Typical examples of non-magnetic powders to be employed in the underlying layer are NANOTAITO (Showa Denko); HIT-100 and ZA-Gl (Sumitomo Chemical); α-hematite DPN-250, DPN-250BX, DPN-245, DPN-270BX, DBN-SAI, and DBN-SA3 (Toda Kogyo); titanium oxide TTO-51B, TTO-55A, TTO-55B, TTO-55C, TTO-55S, TTO-55D, SN-100, α-hematite E270, E271, E300, and E303 (Ishihara Sangyo); titanium oxide STT-4D, STT-30D, STT-30, STT-65C, and α-hematite α-40 (Titan Kogyo); MT-100S, MT-100T, MT-150W, MT-500B, MT-600B, MT-100F, and MT-100HD (Teika); FINEX-25, BF-1, BF-10, BF-20, and ST-M (Sakai Chemical); DEFIC-Y and DEFIC-R (Dowa Kogyo); AS2BM and TiO2P25 (Nippon Aerojiru); 100A and 500A (Ube Kosan); and sinters. Particularly preferred non-magnetic powders are titanium dioxide and α-iron oxide.

If the underlying layer contains carbon black, the surface electric resistance Rs can be lowered, the light transmission factor can be made smaller, and desired micro-Vickers hardness can be obtained. In addition, if the underlying layer contains carbon black, it can have the effect of storing a lubricant. The carbon black types are rubber furnace, rubber thermal, color black, acetylene black, etc. For the carbon black in the underlying layer, the following characteristics should be optimized depending on desired effects, and effects are sometimes obtained by using some of them together.

The specific surface area of the carbon black in the underlying layer (coated layer) is 100 to 500 m²/g, preferably 150 to 400 m²/g. The DBP oil absorption of the carbon black is 20 to 400 ml/100 g, preferably 30 to 200 ml/100 g. The particle size of the carbon black is 5 to 80 μm, preferably 10 to 40 μm. The pH of the carbon black is 2 to 10, and the percentage of water content is 0.1 to 10 wt %. The tap density is preferably 0.1 to 1 g/ml. Preferred examples of carbon black are BLACKPEARLS 2000, 1300, 1000, 900, 800, 880, 700, and VULCAN XC-72 (Cabot); #3050B, #3150B, #3250B, #3750B, #3950B, #950B, #650B, #970B, #850B, MA-600, MA-230, #4000, and #4010 (Mitsubishi Chemical) CONDUCTEX SC, RAVEN 8800, 8000, 7000, 5750, 5250, 3500, 2100, 2000, 1800, 1500, 1255, and 125.0 (Colombia Carbon); Black EC (Akuzo); and so forth. Carbon black may be surface-treated with a dispersant, etc. It may be graphitized with resin, or part of the surface may be graphitized. Furthermore, carbon black may be dispersed with a binder before it is added to a coating. The above-described carbon blacks can be used in a range that does not exceed 50 wt % with respect to the above-described inorganic power and a range that does not exceed 40% of the total weight of the non-magnetic layer. These carbon blacks can be used singly or in combination. For further information on carbon black that can be used in the present invention, see, for example, “Carbon Black Handbook” (Carbon Black Society Editing).

In addition, organic power can be added to the underlying layer, depending on purposes. Examples are acrylic styrene resin powder, benzo guanamine resin powder, melamine resin power, and phthalocyanine pigment. Polyolefin resin powder, polyester resin powder, polyamideres in powder, polyimide resin powder, and polyethylene fluoride resin can also be used. The generation method is described, for instance, in Japanese Unexamined Patent Publication Nos. 62(1987)-18564 and 60(1985)-255827.

Binders, lubricants, dispersants, additives, solvents, methods of dispersion, and others for the underlying layer can employ those for the magnetic layer described below. Particularly, for the binder quantity and type, additive quantity and type, and dispersant quantity and type, conventional techniques for the magnetic layer can be utilized.

Description of Binders

Binders, lubricants, dispersants, additives, solvents, methods of dispersion, and others for the non-magnetic layer can employ those for the magnetic layer. Particularly, for the binder quantity and type, additive quantity and type, and dispersant quantity and type, conventional techniques for the magnetic layer can be utilized.

Binders to be used here are conventional thermoplastic resin, thermosetting resin, reaction type resin, and a mixture of these. Thermoplastic resin that is employed in the present invention has a glass transition temperature of −100 to 150° C., a number average molecular weight of 1000 to 200000, preferably 10000 to 100000, and a polymerization degree of about 50 to 1000.

Such examples are polyurethane resin, various rubber resins, and a polymer or copolymer which contains a constituent unit derived from a monomer such as vinyl chloride, vinyl acetate, vinyl alcohol, maleic acid, acrylic acid, acrylic ester, vinylidene chloride, acrylonitrile, methacrylic acid, ester methacrylate, styrene, butadiene, ethylene, vinylbutyral, vinyl acetal, and vinyl ester. Examples of thermosetting resin and reaction type resin are phenol resin, epoxy resin, polyurethane setting resin, urea resin, melamine resin, alkyd resin, acrylic reaction resin, formaldehyde resin, silicon resin, epoxy-polyamide resin, a mixture of polyester resin and isocyanate prepolymer, a mixture of polyester polyol and polyisocyanate, a mixture of polyurethane and polyisocyanate, etc. These resins are described in detail in “Plastic Handbook” (Asakura bookstore). It is also possible to use electron-beam thermosetting resin in each layer. These examples and the fabrication method are described in detail in Japanese Unexamined Patent Publication No. 62(1987)-25621. The above-described resins can be used singly or in combination. Preferred examples are a combination of at least one selected from the group consisting of vinyl chloride resin, vinyl chloride-vinyl acetate copolymer, vinyl chloride-vinyl acetate-vinyl alcohol copolymer, and vinyl chloride-vinyl acetate-maleic anhydride copolymer, and polyurethane resin, and a combination of these and polyisocyanate.

The structure of polyurethane resin can use a known structure such as polyester-polyurethane, polyether-polyurethane, polyether-polyester-polyurethane, polycarbonate-polyurethane, polyester-polycarbonate-polyurethane, polycaprolactone-polyurethane, etc. For these binders to have excellent dispersibility and durability, it is preferable to introduce at least one polar group, selected from the group consisting of —COOM, —SO₃M, —OSO₃M, —P═O(OM)₂, —O—P═O(OM)₂, —OH, —NR₂, —N+R₃, epoxy group, —SH, —CN (where M represents a hydrogen atom or alkali metal base, and R represents a carbon hydrogen group), into these binders as occasion demands by copolymerization or an addition reaction. The quantity of such a specific group is 10⁻¹ to 10⁻⁸ mole/g, preferably 10⁻² to 10⁻⁶ mole/g.

Examples of these binders are VAGH, VYHH, VMCH, VAGF, VAGD, VROH, VYES, VYNC, VMCC, XYHL, XYSG, PKHH, PKHJ, PKHC, and PKFE (Union Carbite); MPR-TA, MPR-TA5, MPR-TAL, MPR-TSN, MPR-TMF, MPR-TS, MPR-TM, and MPR-TAO (Nisshin Kagaku Kogyo); 1000W, DX80, DX81, DX82, DX83, and 100FD (Denki Kagaku Kogyo); MR-104, MR-105, MR110, MR100, MR555, and 400X-110A (Nippon Zeon); NIPPORAN N2301, N2302, and N2304 (Nippon Polyurethane); PANDEX T-5105, T-R3080, T-5201, BARNOKKU D-400, D-210-80, KURISUBON 6109, and 7209 (Dai Nippon Ink); BYLON UR8200, UR8300, UR-8700, RV530, and RV280 (Toyobo); DAIFERAMINE 4020, 5020, 5100, 5300, 9020, 9022, and 7020 (Dainichiseika Color); MX5004 (Mitsubishi Chemical); SANPUREN SP-150 (Sanyo Chemical); and SARAN F310 and F210 (Asahi Chemical).

A binder that is employed in the underlying layer is in a range of 5 to 50%, preferably 10 to 30%, with respect to non-magnetic powder. A binder that is employed in the magnetic layer is in a range of 5 to 50%, preferably 10 to 30%, with respect to a magnetic substance. In the case of employing a binder along with vinyl chloride resin, the binder is employed in a range of 5 to 30%. In the case of employing a binder along with polyurethane resin, the binder is employed in a range of 2 to 20%. In the case of employing a binder along with polyisocyanate, the binder is employed in a range of 2 to 20%. For example, in the case where head corrosion occurs by a very small amount of dechlorination, it is also possible to use only polyurethane or only polyurethane and isocyanate. In the present invention, in the case of employing polyurethane, the glass transition temperature is −50 to 150° C., preferably 0 to 100° C. Preferably, the rupture elongation is 100 to 2000%, the rupture stress 0.05 to 10 Kg/mm², and the yielding point 0.05 to 10 Kg/mm².

The magnetic recording medium is constructed of two or more layers. Therefore, in the non-magnetic layer and each magnetic layer, it is possible to change the quantity of a binder, to change the quantity of the vinyl chloride resin, polyurethane resin, polyisocyanate, or other resins in a binder, to change the molecular weight of each resin forming the magnetic layer and the quantity of the polar group, and to change the previously described physical properties. Optimization should be performed on each layer, and conventional techniques on a multilayer construction can be utilized. For example, in the case where the quantity of a binder is changed in each layer, it is effective to increase the quantity of the binder of the magnetic layer to reduce flaws in the magnetic layer surface, or the quantity of the binder of the non-magnetic layer can be increased to provide flexibility so that a good head touch is obtained.

Examples of polyisocyanate are isocyanates (such as tolylenediisocyanate; 4,4′-diphenylmethanediisocyanate; hexamethylenediisocyanate, xylilenediisocyanate; naphthylene-1; 5-diisocyanate; o-toluidinediisocyanate; isophoronediisocyanate; triphenylmethanetridiisocyanate; etc.), a product of these isocyanates and polyalcohol, a polyisocyanate generated by condensation of polyisocyanates, and so on. Commercially available isocyanate products are CORONATE-HL, CORONATE-2030, CORONATE-2031, and MILIONATE-MR MILIONATE-MTL (Nippon Polyurethane); TAKENATE D-102, TAKENATE D-110N, TAKENATE D-200, and TAKENATE D-202 (Takeda Chemical); Desmodule L, Desmodule IL, and Desmodule N desmodule HL (Sumitomo Biel); and so forth. These can be employed in each layer singly, or in combination by utilizing a difference in hardenability.

Description of Carbon Black and Abrasives

The carbon black to be used in the above-described magnetic layer can employ rubber furnace, rubber thermal, color black, acetylene black, etc. In a preferred example, the specific surface area is 2 to 500 m²/g, the DBP oil absorption is 10 to 400 ml/100 g, the particle size is 5 to 300 μm, the pH is 2 to 10, the percentage of water content is 0.1 to 10 wt %, and the tap density is 0.1 to 1 g/ml. Preferred examples of carbon black are BLACKPEARLS 2000, 1300, 1000, 900, 905, 880, 700, and VULCAN XC-72 (Cabot); #80, #60, #55, #50, and #35 (Asahi Carbon); #2400B, #2300, #900, #1000, #30, #40, and #10 (Mitsubishi Chemical); CONDUCTEX SC, RAVEN 150, 50, 40, 15, and RAVEN-MT-P (Colombia Carbon); Black EC (Nippon EC); and so forth. Carbon black may be surface-treated with a dispersant, etc. It may be graphitized with resin, or part of the surface may be graphitized. Furthermore, carbon black may be dispersed with a binder before it is added to paint. These carbon blacks can be used singly or in combination. In the case of employing carbon black, it is preferable to employ it in a range of 0.1 to 30 wt % of a magnetic substance. When using carbon black, it is preferable to employ it in a range of 0.1 to 30 wt % of the ferromagnetic substance content. Carbon black can make a contribution to the static charge prevention, reduction in the friction coefficient, light interception, and enhancement in the film strength of the magnetic layer. These depend on the carbon black used. Therefore, these carbon blacks can be used depending on purposes, based on the aforementioned various characteristics such as particle size, oil absorption, conductivity, and pH, by changing type, weight, and combination between the overlying magnetic layer and the underlying non-magnetic layer. Optimization should be performed in each layer. For carbon black that can be used in the above-described magnetic layer, see, for example, “Carbon Black Handbook” (Carbon Black Society Editing).

Examples of abrasives are α-alumina of α-ratio 90% or greater, β-alumina, silicon carbide, chromium oxide, serium oxide, α-iron oxide, corundum, artificial diamond, silicon nitride, silicon carbide titan carbide, titanium oxide, silicon dioxide, and boron nitride. These abrasives with a Moh's hardness of 6 or greater can be employed singly or in combination. A complex consisting of these abrasives (in which one abrasive is surface-treated with another abrasive) may also be used. In the case where these abrasives contain a compound or an element other than their main component, they can be employed without lessening their effect, if their main component is 90% or greater. The particle sizes of these abrasives are preferably 0.01 to 2 μm. Particularly, to enhance the electromagnetic transfer characteristic, narrower particle size distribution is preferable. To enhance durability, abrasives different in size may be combined together as occasion demands, or a particle size distribution for a single abrasive can be made wider. Even in this case, the same effect can be obtained. Preferably, the tap density is 0.3 to 2 g/cc, the percentage of water content 0.1 to 5 wt %, the pH 2 to 11, and the specific surface area 1 to 30 m²/g. An abrasive that is employed in the present invention may be in the form of a needle, a sphere, or a cube. However, an abrasive with an edge in a portion of the shape is preferred because the abrasive property is high. Typical examples are AKP-12, AKP-15, AKP-20, AKP-30, AKP-50, HIT-20, HIT-30, HIT-55, HIT-60, HIT-70, HIT-80, HIT-100 (Sumitomo Chemical); ERC-DBM, HP-DBM, HPS-DBM (Reynozule); WA100 (Fujimi Kenmazai); UB20 (Kamimura Kogyo); G-5, CHROMEX U2, CHROMEX U1 (Nippon Kagaku); TF-100, TF-140 (Toda); Beta random ultrafine (Ibiden); and B-3 (Showa Kogyo). These abrasives can be added to the non-magnetic layer as occasion demands. If an abrasive is added to the non-magnetic layer, the surface shape can be controlled, or the state of protrusion of the abrasive can be controlled. The particle size and quantity of an abrasive that is added to the magnetic layer and non-magnetic layer should be set to optimum values, respectively.

Description of Additives

The additives that are used in the magnetic layer and the non-magnetic layer have a lubrication effect, an static charge prevention effect, a dispersion effect, a plastic effect, etc. Examples are molybdenum disulfide; tungsten graphite disulfide; boron nitride; graphite fluoride; silicon oil; silicon oil with a polar group; fatty acid modified silicon; fluorine-contained silicon; fluorine-contained alcohol; fluorine-contained ester; polyolefin; polyglycol; alkylphosphate and an alkali metal salt thereof; alkylsalfate and an alkali metal salt thereof; polyphenylether; phenylphosphonic acid; aminoquinones; various silane coupling agents; titan coupling agent; fluorine-contained alkylsalfate and an alkali metal salt thereof; monobasic fatty acids of carbon numbers 10 to 24 (which may contain an unsaturated bond or may branch) and alkali metal salts of these (Li, Na, K, Cu, etc.); monohydric, dihydric, trihydric, tetrahydric, pentahydric, hexahydric alcohols of carbon numbers 12 to 22 (which may contain an unsaturated bond or may branch); alkoxyl alcohols of carbon numbers 12 to 22; monofatty acid ester or difatty acid ester or trifatty acid ester which comprises any one of monobasic fatty acids of carbon numbers 10 to 24 (which may contain an unsaturated bond or may branch) and monohydric, dihydric, trihydric, tetrahydric, pentahydric, hexahydric alcohols of carbon numbers 12 to 22 (which may contain an unsaturated bond or may branch); fatty acid ester of monoalkylether of an alkylene oxide polymer; fatty acid amides of carbon numbers 8 to 22; and fatty acid amines of carbon numbers 8 to 22.

Examples of fatty acids are capric acid, caprylic acid, lauric acid, myristic acid, palmitic acid, stearic acid, behenic acid, oleic acid, elaidic acid, linoleic acid, linolenic acid, isostearic acid, etc. Examples of esters are butyl stearate, octylstearate, amylstearate, isooctylstearate, butylmyristate, octyl myristate, butoxy ethyl stearate, butoxy diethyl stearate, 2-ethyl hexyl stearate, 2-octyldodecil palmitato, 2-hexyldodecil palmitato, isohexadecil stearate, oleyl oleate, dodecilstearate, tridecil stearate, erucicacidoleyl, neopentyl glycol didecanoate, etc. Examples of alcohols are oleyl alcohol, stearyl alcohol, lauryl alcohol, etc. A nonionic surface active agent (such as alkylene oxide, glycerin, glycidol, an alkylphenolethylene oxide addition, etc.), a cationic surface active agent (such as a ring amine, esteramide, quaternary ammonium salts, a hydantoin derivative, a heterocyclic compound, a phosphonium or sulphonium compound, etc.) an anionic surface active agent containing an acid group (such as carboxylic acid, sulfonic acid, phosphoric acid, sulfuric ester group, phosphoric ester group, etc), and an amphoteric surface active agent (such as amino acids, amino sulfonic acids, sulfuric acid or phosphoric acid esters of amino alcohol, alkylbetaine types, etc.) can also be used. These surface active agents are described in detail in “Surface Active Agent Handbook” (Sangyo books). These lubricants, antistatic agents, etc., do not always have to be 100% pure. That is, in addition to the chief ingredient, they may contain impurities such as ametamer, an unreacted substance, a side reactant, a decomposed substance, an oxide, etc. It is preferable that these impurities be 30% or less and further preferable that it be 10% or less.

These lubricants and surface active agents have individual different physical operations. The type, quantity, and the ratio of a lubricant and a surface active agent producing a synergistic effect should be determined optimally depending on purposes. For example, (1) different fatty acids whose melting point is different are employed in the non-magnetic layer and the magnetic layer to control the oozing of an additive through the surface; (2) different esters whose boiling point, melting point, and polarity are different are employed in the non-magnetic layer and the magnetic layer to control the oozing of an additive through the surface; (3) the amount of a surface active agent is adjusted to enhance the stability of coating; and (4) the amount of a lubricant in an intervening layer is increased to enhance a lubrication effect. These are merely examples. Generally, the total amount of a lubricant is 0.1 to 50%, preferably 2 to 25%, with respect to a magnetic substance or non-magnetic powder.

The whole or par of an additive to be used here may be added in any of the steps of forming magnetic and non-magnetic layers. For example, there are a case where an additive is mixed with a magnetic substance before the kneading step; a case where an additive is added in the step of kneading a magnetic substance, a binder, and an organic solvent; a case where an additive is added in a dispersion step; a case where an additive is added after dispersion; and a case where an additive is added immediately before layer formation. In addition, there are cases where after a magnetic layer is formed depending on a purpose, the purpose is achieved by applying the whole or part of an additive at the same time or in sequence. Furthermore, after calendering or after slit formation, a lubricant can be coated on the magnetic layer surface depending on the purpose.

An organic solvent can use a conventional one and employ, for example, a solvent described in Japanese Unexamined Patent Publication No. 60(1985)-68453.

Description of Layer Construction and Shape

There is provided an intervening layer between the flexible non-magnetic support and the underlying layer (or the magnetic layer) to enhance the intimate contact between the two. The thickness of the intervening layer is 0.01 to 2 μm, preferably 0.02 to 0.5 μm. In the present invention, a non-magnetic layer and a magnetic layer are formed on both sides of a support, but may be formed on only one side. In this case, there may be provided a back coating on the side opposite to the non-magnetic layer and magnetic layer to obtain a static charge prevention effect and a curl-correction effect. This thickness is 0.1 to 4 μm, preferably 0.3 to 2 μm. The above-described intervening layer and back coating are well known in the prior art.

The thickness of the magnetic layer of the magnetic recording medium is optimized, depending on a read/write head to be used and the band of signals to be recorded. Typically, the thickness is 0.01 and 1.0 μm, preferably 0.03 to 0.2 μm. The magnetic layer may be separated into two or more layers having a different magnetic characteristic, and the construction of a magnetic multilayer known in the prior art can be utilized.

The thickness of the non-magnetic layer (underlying layer) of the recording medium is 0.2 to 5 μm, preferably 0.5 to 3.0 μm, and further preferably 1.0 to 2.5 μm. Note that the underlying layer exhibits its effect if it is practically non-magnetic. For instance, even if the underlying layer contains impurities or purposely contains a small quantity of magnetic substance, it can be considered to be practically the same construction. The expression “practically the same construction” means that the residual magnetic flux density of the underlying layer is 100 G or less, or the coercive field is 100 Oe or less. Preferably, the underlying layer has no residual magnetic flux density and no coercive field.

Description of the Support

The non-magnetic support to be employed here can employ materials known in the prior art, but polyethyleneterephthalate film, polyethylenenaphthalate film, aramide film, and polycarbonate film are preferred. The thickness is optimized according to disk diameter and disk speed, but as previously described, it is typically between 20 and 100 μm.

Multilayered supports can be employed to provide surface roughness between a magnetic surface and a base surface as occasion demands. These supports may previously undergo a corona discharge treatment, a plasma treatment, an easy adhesion treatment, a heat treatment, a dust removing treatment, etc.

For the non-magnetic supports, the center surface average surface roughness Ra, measured by an optical interference surface roughness tester (TOPO-3D made by WYKO), is 10 nm or less, preferably 5 nm or less. In preferred supports, not only is the surface center average surface roughness small, but there is no projection of 200 nm or greater. The surface roughness shape can be freely controlled by the size and quantity of filler that is added to a support as occasion demands. Examples are an oxide or carbonate with Ca, Si, Ti, etc., and acrylic organic powder. In a preferred example, the maximum height of a support is 1 μm or less, the 10-point average roughness Rz is 200 nm or less, the center surface mountain height Rp is 200 nm or less, the center surface valley depth Rv is 200 nm or less, and the average wavelength is 5 to 300 μm.

The heat contraction coefficient of the non-magnetic support for 30 min at 105° C. is 0.5% or less, preferably 0.3% or less. The heat contraction coefficient for 30 min at 80° C. is 0.3% or less, preferably 0.2% or less. The heat contraction coefficient for 1 week at 60° C. is 0.05% or less, preferably 0.02% or less. The temperature expansion coefficient is 10⁻⁴ to 10⁻⁸/° C., preferably 10⁻⁵ to 10⁻⁶/° C. The humidity expansion coefficient is 10⁻⁴/RH % or less, preferably 10⁻⁵/RH % or less. It is preferable that the thermal characteristic, dimension characteristic, and mechanical strength characteristic be approximately equal within a difference of 10% in each direction within the surface of the support.

Description of a Fabrication Method

The step of forming the magnetic layer of the magnetic recording medium includes at least a kneading step, a dispersion step, and mixing steps provided as needed before and after these steps. Each step may be performed in two or more stages. The above-described magnetic substance, non-magnetic powder, binder, carbon black, abrasive, antistatic agent, lubricant, and solvent may be added at the beginning or in the middle of any step. In addition, each material may be divided and added in two or more steps. For instance, polyurethane may be divided and added in the kneading step, the dispersion step, and the mixing step for adjusting viscosity after dispersion. To achieve purposes, a conventional fabrication technique can be employed as some of the above-described steps. The kneading step preferably uses a kneader having a kneading force, such as an open kneader, a continuous kneader, a pressure kneader, and an extruder. In the case of employing a kneader, the kneading process is performed in a range of 15 to 500 parts with respect to a magnetic substance (or non-magnetic powder), the whole or part of a binder (30% or greater is preferred), and a magnetic substance 100. The details of these kneading process are described in U.S. Pat. Nos. 4,946,615 and 5,300,244. Glass beads can be employed to disperse a magnetic layer solution and a non-magnetic layer solution, but in the disperse of hexagonal ferrite, a dispersing medium with a high specific gravity, such as zirconia beads, titania beads, and steel beads, are suitable. The particle size and fill amount of these dispersing medium are optimized and used. A dispersing machine can use a conventional one.

In the case of coating a multilayered magnetic recording medium, it is preferred to employ the following methods.

In a first method, an underlying layer is first formed by a photogravure coater, a roll coater, a blade coater, or an extrusion coater which is generally employed to apply a coating solution for a magnetic layer, and when the underlying layer is in a wet state, an overlying layer is formed by a press-type extrusion coater disclosed in Japanese Unexamined Patent Publication No. 1(1989)-46186 and U.S. Pat. Nos. 4,681,062 and 5,302,206. In a second method, an overlying layer and an underlying layer are formed at nearly the same time by a single coating head with two slits through which a coating solution is passed, such as those disclosed in U.S. Pat. Nos. 4,854,262, 5,030,484, 5,072,688 and 5,302,206. In a third method, an overlying layer and an underlying layer are formed at approximately the same time by an extrusion coater with a backup roll disclosed in Japanese Unexamined Patent Publication No. 2(1990)-174965. Note that to prevent a reduction in the electromagnetic conversion characteristic, etc,. of a magnetic recording medium due to the condensation of magnetic particles, it is desirable to apply shearing to a coating solution within the coating head by a method such as that disclosed in U.S. Pat. No. 4,828,779 and Japanese Unexamined Patent Publication No. 1(1989)-236968. Furthermore, the viscosity of a coating solution has to satisfy a numerical range disclosed in Japanese Unexamined Patent Publication No. 3(1991)-8471. To realize the construction of the present invention, sequential multilayer coating can be employed in which an underlying layer is applied and dried and then a magnetic layer is provided on the underlying layer.

In the case of disks, sufficiently isotropic orientation is sometimes obtained without an orientation unit, but it is preferable to employ a conventional random orientation unit such as a unit for arranging cobalt magnets obliquely and alternately, a unit for applying an alternating magnetic field with a solenoid, etc. In the case of hexagonal ferrite, three-dimensional random orientation (in-plane and vertical directions) is easily obtained, but two-dimensional random orientation (in-plane direction) can be employed. If vertical orientation is obtained by a conventional method such as opposed magnets of opposite polarities, isotropic magnetic characteristics can be applied in the circumferential direction. Particularly, in the case of performing high-density recording, vertical orientation is preferred. It is also possible to obtain circumferential orientation by a spin coater.

It is preferable to control the position at which a coating is dried, by controlling the temperature and quantity of a drying wind and a coating speed. It is preferable that the coating speed be 20 to 1000 m/min and the temperature of a drying wind 60° C. or greater. In addition, a coating can be suitably pre-dried before entering a magnet zone.

The calendering of a magnetic recording medium employs a heat-resisting plastic roll, such as epoxy, polyimide, polyamide, polyimideamide, etc., or a metal roll, but in the case of a double-sided medium, it is preferable to surface-treat the medium with two metal rolls. The temperature is preferably 50° C. or greater and further preferably 100° C. or greater. The line pressure is preferably 200 kg/cm or greater and further preferably 300 kg/cm or greater.

Description of Physical Characteristics

The saturation magnetic flux density of the magnetic layer of the magnetic recording medium above described is between 8×10⁻² T and 30×10⁻² T (between 800 G and 3000 G). The coercive field Hc and Hr are 120×10³ A/m to 320×10³ A/m (1500 Oe to 4000 Oe), preferably 180×10³ A/m to 240×10³ A/m (2000 Oe to 3000 Oe). The coercive field distribution is preferably narrower, and SFD and SFDr are preferably 0.65 or less. In the case of random orientation, the square ratio is preferably 0.45 to 0.65, and in the case of vertical orientation, it is 0.6 or greater, preferably 0.7 or greater. When a correction is made by a reversing field, it is 0.7 or greater, preferably 0.8 or greater. In either case, the orientation ratio is preferably 0.8 or greater.

The friction coefficient of a magnetic recording medium relative to a read/write head is 0.5 or less, preferably 0.3 or less, in a range of temperature −10 to 40° C. and humidity 0% to 95%. The surface specific resistance is preferably 10⁴ to 10¹² Ω/sq at a magnetic surface, and the potential is preferably −500 V to +500 V. The elastic modulus at 0.5% elongation of a magnetic layer is preferably 100 to 2000 kg/mm² in each in-plane direction. The rupture strength is preferably 10 to 70 kg/mm² and the elastic modulus of a magnetic recording medium is preferably 100 to 1500 kg/mm² in each in-plane direction. The residual elongation is preferably 0.5% or less. The heat contraction at any temperature less than 100° C. is preferably 1% or less, further preferably 0.5% or less, and even further preferably 0.1% or less. The glass transition temperature of a magnetic layer (the maximum point of the loss elastic modulus of a dynamic elastic measurement made at 110 Hz) is preferably between 50 and 120° C., and that of the underlying non-magnetic layer is preferably 0 to 100° C. The loss elastic modulus is preferably in a range of 1×10³ to 8×10⁴ N/cm² (1×10⁸ to 8×10⁹ dyne/cm²). It is preferable that the loss tangent be 0.2 or less. If it is too great, adhesion failure tends to occur. It is preferable that these heat characteristics and mechanical characteristics be approximately the same within 10% in each in-plane direction of a magnetic recording medium. The residual solvent contained in a magnetic layer is preferably 100 mg/mm² or less and further preferably 10 mg/m² or less. The void ratios for an underlying layer (non-magnetic layer) and a magnetic layer are both preferably 30 capacity % or less and further preferably 20 capacity % or less. It is preferable that the void ratio be small to obtain high output, but there are cases where a certain value is ensured depending on purposes. For example, in the case of disk media that are repeatedly used, better traveling durability is often obtained at a greater void ratio.

The center surface average surface roughness Ra of the magnetic layer, measured by an optical interference surface roughness tester (TOPO-3D made by WYKO), is 5 nm or less, preferably 3 nm or less, and further preferably 2 nm or less. In a preferred example, the maximum height Rmax of the magnetic layer is 200 nm or less, the 10-point average roughness Rz is 80 nm or less, the center surface mountain height Rp is 80 nm or less, the center surface valley depth Rv is 80 nm or less, and the average wavelength is 5 to 300 μm. Preferably, surface projections with a size of 0.01 to 1 μm are set arbitrarily in a range of 0 to 2000, and the friction coefficient is optimized. These can be easily controlled by the control of the surface flatness of a support by filler, the size and quantity of powder to be added to a magnetic layer, the shape of the surface of a calender roll, etc.

In the case where the above-described magnetic recording medium has a non-magnetic layer and a magnetic layer, physical characteristics may be changed between the two layers, depending on purposes. For instance, the elastic modulus of the magnetic layer is made higher to enhance traveling durability, whereas the elastic modulus of the non-magnetic layer is made lower than that of the magnetic layer to make the contact of a read/write head with the magnetic recording medium better.

### Embodiments

<Generation of Coatings>

[Magnetic Coating]
Barium ferrite magnetic powder

| | |
|---|---|
| Mole ratio composition versus Fe: | Ba 8.0, Zn 4.0, Al 4.0, Nb 2.0, |
| | Co 1.0 Ni 0.2, Mn 0.2, P 0.1, |
| | Ca 0.05, Cr 0.02 |
| Hc: | 96 A/m (2400 Oe) |
| Specific surface product: | 60 m²/g, |
| σs: | 60 (Wb · m)/kb (60 emu/g) |
| Plate size: | 22 nm, Plate ratio: 3.0 |
| pH: | 6.8 |
| Polyurethane | 14 parts |
| (functional group SO₃Na | |
| 350 mm equivalent/g) | |
| Particle Diamond | 3 parts |
| (average particle size 0.1 μm) | |
| Alumina | 1 part |
| (average particle size 0.15 μm) | |
| Carbon black | 1 part |
| (average particle size 0.09 μm) | |
| Butyl stearate | 2 parts |
| Butoxyethyl stearate | 2 parts |
| Isohexadecil stearate | 2 parts |
| Stearic acid | 1 part |
| Methyl ethyl ketone | 160 parts |
| Cyclohexane | 160 parts |

[Non-magnetic Coating]

| | |
|---|---|
| Non-magnetic powder | 80 parts |
| α-Fe₂O₃ hematite | |
| Major axis length: | 0.06 μm |
| Specific surface area by BET: | 70 m²/g |
| pH: | 9 |
| Surface treatment agent: | Al₂O₃ 8 wt % |
| Carbon black | 25 parts |
| (average particle size 20 nm) | |
| Polyurethane | 12 parts |
| (functional group SO₃Na | |
| 350 mm equivalent/g) | |
| Phenylphosphonic acid | 2 parts |
| Butyl stearate | 3 parts |
| Butoxyethyl stearate | 3 parts |
| Isohexadecil stearate | 3 parts |
| Stearic acid | 1 part |
| Methyl ethyl ketone/cyclohexane | 250 parts |
| (8/2 mixed solvent) | |

### Description of Embodiments

For the above-described two coatings, the ingredients were kneaded with a kneader, and were dispersed with zirconia beads by a sand mill. In the dispersed solution, 13 parts of polyisocyanate were added to a coating solution for the non-magnetic layer, and 4 parts of polyisocyanate were added to a coating solution for the magnetic layer. Furthermore, 30 parts of methyl ethyl ketone were added to each of the two coating solutions. Next, they were passed through a filter with an average bore diameter of 1 μm, and a coating solution for the non-magnetic layer and a coating solution for the magnetic layer were prepared.

The non-magnetic layer coating solution was applied to both sides of a polyethylenenaphthalate support of center surface average surface height 3 nm to a predetermined thickness so that the thickness after drying becomes 1.5 μm. Then, the magnetic layer coating solution was applied to both sides of the support so that the thickness after drying becomes 0.8 μm. After drying, it was treated at a temperature of 90° C. and a line pressure of 300 kg/cm with a 7-roll calender. A magnetic medium was stamped out so as to have predetermined outside and inside diameters, and the surface was polished. In this way, a magnetic disk was made and housed in a magnetic disk cartridge.

When signals of line recording density 98 kb/cm² (250 kbpi) are written to or read from the disk with an MR head in which a track pitch is 1.5 μm (track density 6.3 kt/cm² (16.9 ktpi) and a track width is 1.0 μm, the surface recording density is 0.65 Gbit/cm²(4.2 Gbit/in²). Although that surface recording density depends upon the settings of the recording area, it is equivalent to a capacity of about 1.6 GB in the case of a disk of outside diameter 50 mm and to a capacity of about 0.4 GB in the case of a disk of outside diameter 25 mm.

Next, embodiments of the present invention will be described in detail with reference to the drawings.

Note that in the drawings, the dimensions of each member are shown in different ratios to facilitate the understanding of the present invention. For example, in a hub, the ratio of the outside diameter to the thickness is greatest, and a magnetic disk is thinner by far than the thickness of the hub.

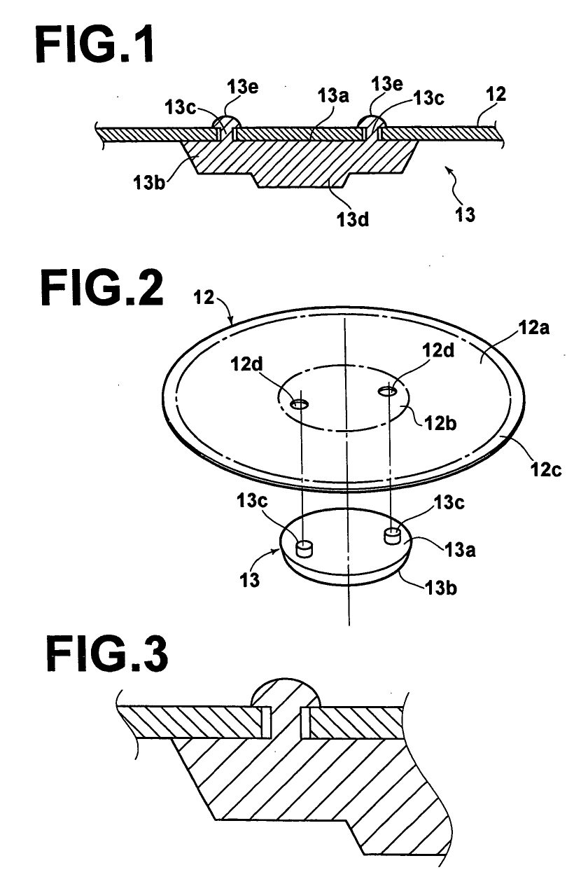

FIG. 1 shows a sectional view of the rotating body of a magnetic disk cartridge constructed in accordance with a first embodiment of a first invention, FIG. 2 shows an exploded perspective view of the rotating body, and FIG. 3 shows an enlarged sectional view of the principal part of the rotating body.

The rotating body includes a flexible magnetic disk 12, and a hub 13 for firmly holding the central portion of the magnetic disk 12. Note that this magnetic disk cartridge constitutes a small magnetic disk cartridge that can be inserted in a disk drive unit installed in the card slot of a personal computer, etc.

The magnetic disk 12 includes a flexible support formed from polyethylene terephthalate (PET), etc., and magnetic layers formed on both sides of the substrate. As illustrated in FIG. 2, the disk 12 has a central portion (non-recording area) 12b, an outer circumferential edge portion (non-recording area) 12c, and a recording area 12a between the central portion 12b and outer circumferential edge portion 12c. The central non-recording area 12b is provided with 2 (two) guide holes 12d by way of example.

The hub 13 is formed by cutting, for example, a stainless steel (JIS SUS) sheet. This hub 13 is equipped with a circular plate portion 13b whose top surface is a disk-holding surface 13a, 2 (two) circular cross-section disk-holding protrusions 13c, and an engagement portion 13d protruding from the bottom surface of the circular plate portion 13b. Note that the engagement portion 13d is engaged by the drive spindle of a disk drive unit (not shown).

The magnetic disk 12 is placed on the disk-holding surface 13a of the hub 13, with the disk-holding protrusions 13c inserted in the guide holes 12d. Then, the tip ends of the disk-holding protrusions 13c protruding from the guide holes 12 are caulked like a rivet and formed into diameter-enlarged portions 13e that serve as anti slip-out means.

In the first embodiment shown in FIGS. 1 to 3, the rotational movement of the magnetic disk 12 relative to the hub 13 is prevented by the disk-holding protrusions 13c provided on the disk-holding surface 13a of the hub 13. Unlike the case where the magnetic disk 12 is fixed to the hub 13 by adhesion, there is no possibility that the magnetic disk 12 will be deformed by residual stress produced when both are fixed together, and consequently, stable disk characteristics are obtained.

In addition, since the tip ends of the disk-holding protrusions 13c are formed into the diameter-enlarged portions 13e, there is no possibility that the magnetic disk 12 will slip out from the disk-holding protrusions 13c.

In the first embodiment, as clearly shown in FIG. 3, the inside diameter of the guide holes 12d of the magnetic disk 12 is made larger than the outside diameter of the disk-holding protrusions 13c to provide clearance between the two. Therefore, even if residual stress is exerted on the magnetic disk 12, it is removed in the clearance provided in the non-recording area 12b, and the recording area 12a of the magnetic disk 12 can avoid undergoing residual stress.

In the first embodiment, the tip end of the disk-holding protrusion 13c is caulked to form the diameter-enlarged portion 13e so that the magnetic disk 12 does not slip out from the disk-holding protrusion 13c. Instead of the above-described caulking, a circular plate larger in diameter than the guide hole 12d may be mounted on the tip face of the disk-holding protrusion 13c.

The number of disk-holding protrusions 13c in the hub 13 is not limited to the two protrusions in the first embodiment. A suitable number of protrusions such as 3 or 4 protrusions can be provided, but it is preferable that they be arranged symmetrically with respect to the center of rotation of the hub 13.

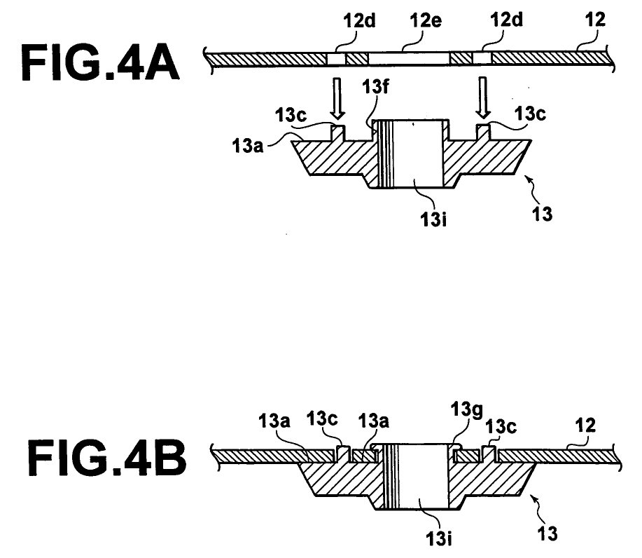

FIGS. 4A and 4B show a magnetic disk and a hub, constructed in accordance with a second embodiment of the first invention. As shown in FIG. 4A, the magnetic disk 12 has guide holes 12d into which the disk-holding protrusions 13c are inserted, as with the first embodiment. In additions to these, it further has a center hole 12e. On the other hand, the disk-holding surface 13a of the hub 13 is provided with a center hole 13i, and a center cylindrical portion 13f that is inserted into the disk center hole 12e. With the center cylindrical portion 13f and disk-holding protrusions 13c of the hub 13 inserted in the center hole 12e and guide holes 12d of the magnetic disk 12, the disk 12 is placed on the disk-holding surface 13a of the hub 13. Then, by caulking the tip end of the center cylindrical portion 13f protruding from the magnetic disk 12, it is formed into a diameter-enlarged portion 13g that serves as anti slip-out means, as shown in FIG. 4B.

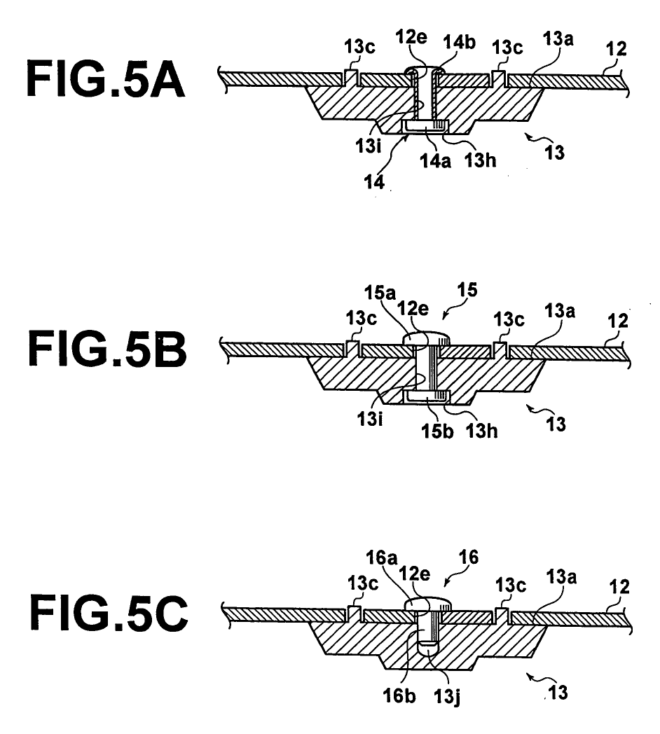

FIGS. 5A, 5B, and 5C show a third embodiment of the first invention. The third embodiment is characterized in that anti slip-out means and a hub 13 are separately formed. As with the second embodiment, a magnetic disk 12 is equipped with guide holes 12d and a center hole 12e, but the center hole 12e is smaller in diameter than that shown in FIG. 4.

In the construction shown in FIG. 5A, an aluminum anti slip-out rivet 14 with a diameter-enlarged head portion 14a is inserted in the center hole 13i of a hub 13 through the lower end of the center hole 13i, the head portion 14a is buried within the recess 13h of the hub 13 so that the tip end protrudes from the magnetic disk 12, and this protruding portion is formed into a diameter-enlarged portion 14b by caulking.

In the construction shown in FIG. 5B, a resin anti slip-out rivet 15 with a diameter-enlarged head portion 15a is inserted in the center hole 13i of a hub 13 through the center hole 12e of a magnetic disk 12, the tip end of the anti slip-out rivet 15 is protruded into the recess 13h of the hub 13, and this protruding portion is formed into a diameter-enlarged portion 15b by fusing.

In the construction shown in FIG. 5C, an anti slip-out screw 16 with a diameter-enlarged head portion 16a is press-fitted in the center hole (bottomed hole) 13j of a hub 13 through the center hole 12e of a magnetic disk 12, or it is fixed to the center hole 13j with an adhesive.

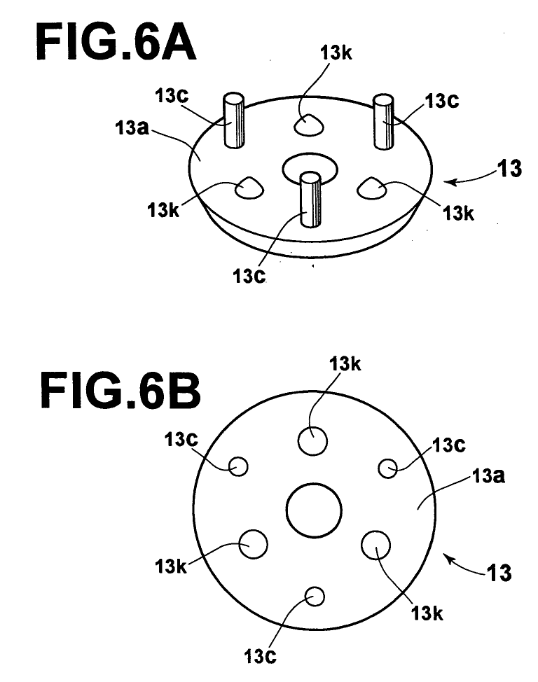

FIGS. 6A and 6B show a hub constructed in accordance with a fourth embodiment of the first invention.

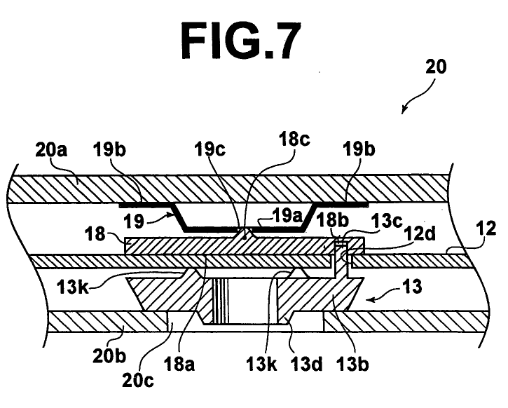

The fourth embodiment is characterized in that in addition to 3 (three) disk-holding protrusions 13c, the disk-holding surface 13a of a hub 13 is equipped with 3 (three) disk-holding projections 13k. Preferably, these disk-holding projections 13k are arranged symmetrically with respect to the center of rotation of the hub 13, as with the disk-holding protrusions 13c. The tip ends of the 3 disk-holding projections 13k constitute a disk-holding plane parallel to the disk-holding surface 13a, and make point-contact with the magnetic disk 12 and hold it in parallel with the disk-holding surface 13a. The anti slip-out means in this case can adopt the same structure as that shown in FIG. 1. It can also be constructed as shown in FIG. 7.

In a magnetic disk cartridge 20 shown in FIG. 7, a casing includes an upper shell 20a and a lower shell 20b, and a hub 13 is housed within the casing so that the engagement portion 13d is exposed through the center hole 20c of the lower shell 20b. When the magnetic disk cartridge is in an inoperative state, the bottom surface of the circular plate portion 13b of the hub 13 is in contact with the inner wall of the lower shell 20b. The magnetic disk 12 is held by the 3 disk-holding projections 13k, and the 3 disk-holding protrusions 13c pass through the guide holes 12d of the magnetic disk 12 and protrude from the top surface of the magnetic disk 12.

The central portion of the top surface of the magnetic disk 12 is in contact with the flat bottom surface 18a of a press plate 18 of approximately the same diameter as that of the circular plate portion 13b of the hub 13. The bottom surface 18a of the press plate 18 is provided with 3 (three) bores 18b for housing the tip ends of the 3 disk-holding protrusions 13c protruding from the top surface of the magnetic disk 12. The top surface of the press plate 18 is also provided with a center projection 18c. Between the press plate 18 and the inner wall surface of the upper shell 20, there is interposed a plate spring 19. This plate spring 19 includes a main plate portion 19 arranged approximately parallel to the inner wall surface of the upper shell 20a, and a pair of leg portions 19b extending from both ends of the main plate portion 19a and reaching the inner wall surface of the upper shell 20a. The center of the main plate portion 19a has a supporting bore 19c by which the center projection 18c of the press plate 18 is rotatably supported.

The above-described press plate 18 and plate spring 19 constitute anti slip-out means, and the magnetic disk 12 is held stably on the hub 13 by the 3 disk-holding projections 13k. If the hub 13 is moved away from the inner wall surface of the lower shell 20b by engagement with the drive spindle (not shown) of a disk drive unit, the press plate 18 is rotatably supported with the plate spring 19 slightly depressed.

According to the embodiment shown in FIG. 7, in addition to the advantages obtained by holding the magnetic disk 12 with the disk-holding protrusions 13c of the hub 13, the magnetic disk 12 is held in point-contact with the 3 disk-holding projections 13k of the hub 13, so more stable disk characteristics can be obtained.

In the above-described embodiments, while the present invention has been applied to a magnetic disk cartridge with a 1.8-in (about 46 mm) disk, the invention is also applicable to conventional disk cartridges with a 3.5-in (about 89 mm) floppy disk. As with the above-described embodiments, the above-described advantages are obtainable.

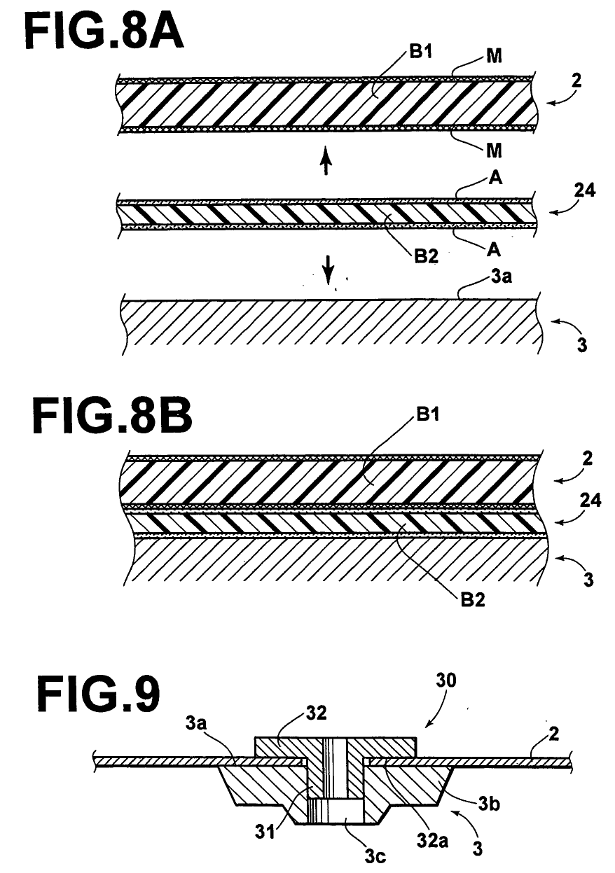

FIGS. 8A and 8B show a magnetic disk cartridge constructed in accordance with a second invention. In this magnetic disk cartridge, a magnetic disk 2 is firmly held on the disk-holding surface 3 of a hub 3 with an adhesive double-coated tape 24.

As shown in FIG. 8A, the magnetic disk 2 includes a flexible support B1 formed from PET resin, and magnetic layers M (such as barium ferrite (BaFe)) formed on both sides of the support B1. The adhesive double-coated tape 24 includes a substrate B2 formed from PET resin, and adhesive layers A formed on both sides of the substrate B2. The top adhesive layer A of the double-coated tape 24 is attached to the magnetic disk 2, and then the bottom adhesive layer A is attached on the disk-holding surface 3a of a hub 3. In this way, the magnetic disk 2 is firmly held on the disk-holding surface 3a of the hub 3.

Such a construction is suitable for a magnetic disk cartridge having a magnetic disk of 2 in (about 50.8 mm) or less in diameter such as the aforementioned “click! (R),” which is inserted in a TPYE II PC card drive unit with an MR head and used in personal computers or moving-picture and still-picture cameras. This magnetic disk 2 has a storage capacity of 1 GB or greater and a recording density of 3 Gbit/square in or greater, and the tracks are written at intervals of a 1-μm pitch by magnetic transfer.

A thermal expansion coefficient for PET resin is 2 to 3×10⁻⁵/° C., whereas a thermal expansion coefficient for acrylic resin employed in the substrate B2 and adhesive layers A of the double-coated tape 24 differs greatly such as 6 to 10×10⁻⁵/° C. In the embodiment shown in FIG. 8, the same material (PET resin) is employed in the flexible support B1 of the magnetic disk 2 and the substrate B2 of the adhesive double-coated tape 24, so the thermal expansion coefficients of the two are approximately the same. Therefore, even when the ambient temperature changes, the support B1 of the magnetic disk 2 is deformed the same as the substrate B2 of the adhesive double-coated tape 24, so they are less liable to undergo strain.

In the case where the flexible support B1 of the magnetic disk 2 is formed from PET resin, a preferred example of the adhesive double-coated tape 24 is tesa4983 (manufactured by Tesa Tape). An adhesive double-coated tape with this PET resin as its substrate is very thin such as 0.03 mm, because it uses extremely thin adhesive layers A. In contrast, an adhesive double-coated tape consisting of only adhesive layers without a substrate, which is adopted in the current “clik!,” is 0.1 mm in thickness. By employing the adhesive double-coated tape 24 in which the adhesive layer (which differs in thermal expansion coefficient from the substrate) is thin, the occurrence of wrinkles and strain can be more effectively minimized.

In general, the adhesive double-coated tape 24 is first attached to the magnetic disk 2, and then it is attached to the hub 3. In this case, the adhesive double-coated tape 24 with the substrate B2 is used, so it becomes firmer and can be attached readily to the magnetic disk.

In the above-described embodiment, while the flexible support B1 of the magnetic disk 2 and the substrate B2 of the adhesive double-coated tape 24 employ the same material (PET resin), the materials do not always have to be the same. It is preferable that a difference in thermal expansion coefficient between the flexible support B1 and the substrate B2 be within ±2×10⁻⁵/° C. and further preferable that it be within ±1×10⁻⁵/° C.

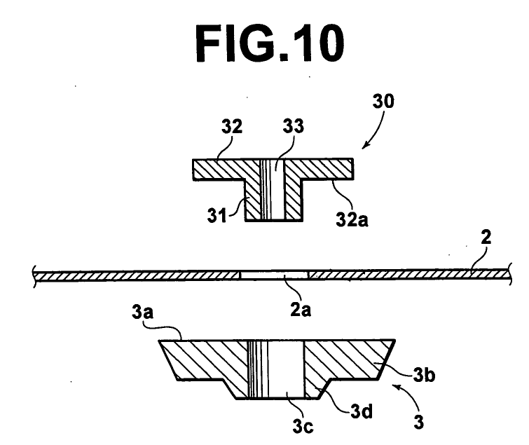

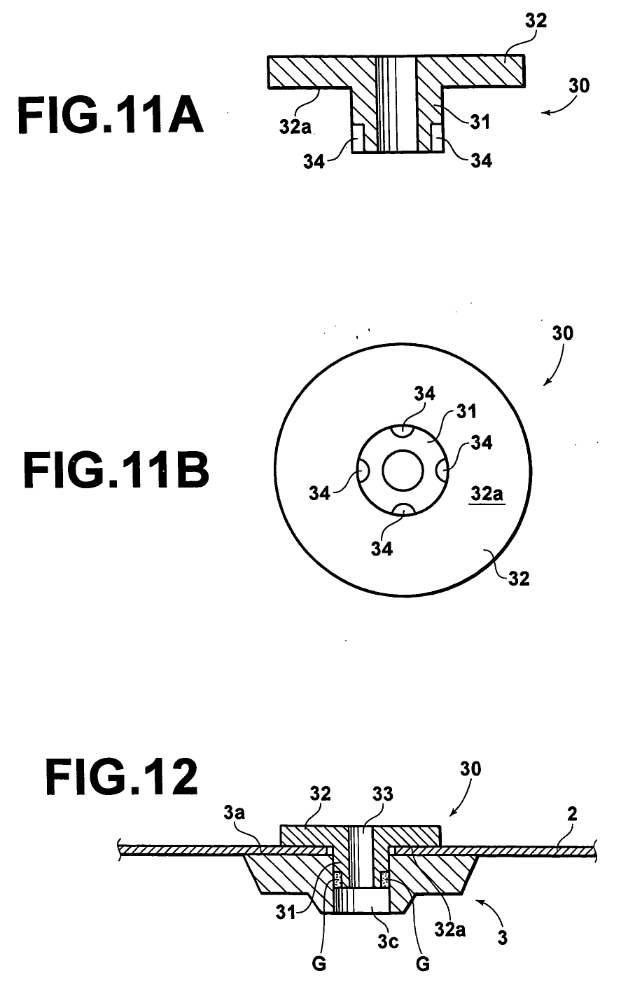

FIG. 9 shows the rotating body of a magnetic disk cartridge constructed in accordance with a third invention; FIG. 10 shows an exploded sectional view of the rotating body shown in FIG. 9.

In the figures, a magnetic disk 2 and a hub 3 have center holes 2a, 3c, respectively. The hub 3 includes a circular plate portion 3b having a disk-holding surface 3a, and an engagement portion 3d extending downward from the bottom surface of the circular plate portion 3b.

The embodiment, shown in FIGS. 9 and 10, is characterized in that it is equipped with a disk-clamping member 30. This disk-clamping member 30 includes a cylindrical portion 31, a flange portion 32 formed integrally with the cylindrical portion 31, and a center hole 33. The cylindrical portion 31 is inserted through the center hole 2a of the magnetic disk 2 placed on the disk-holding surface 3a of the hub 3, and is fitted in the center hole 3c of the hub 3. The bottom surface 32a of the flange portion 32 forms a disk press surface, which presses the magnetic disk 2 against the top surface 3a of the hub 3 and mechanically holds the magnetic disk 2.

According to the embodiment shown in FIGS. 9 and 10, unlike the case where the magnetic disk 2 is fixed to the hub 3 with an adhesive, there is no possibility that wrinkles or strain will occur in the magnetic disk 2 by residual stress produced when the two are fixed, and consequently, stable disk characteristics are obtained. In comparison with FIG. 7, there is also an advantage that the conventional magnetic disk 2 and hub can be utilized as they are.

In this case, if the cylindrical portion 31 of the disk-clamping member 30 is constructed so that it is press-fitted in the center hole 3c of the hub 3, the disk-clamping member 30 can be fixed to the hub 3. In addition, if the outer periphery of the lower portion of the cylindrical portion 31 is provided with a plurality of recesses 34, and the recesses 34 are filled with an adhesive G before the cylindrical portion 31 is fitted in the center hole 3c of the hub 3, the disk-clamping member 30 can be fixed to the hub 3, as shown in FIG. 12.

The adhesive G in this case can be held without contacting the magnetic disk 2, so there is no possibility that it will have detrimental effects on the characteristics of the magnetic disk 2.

If the hub 3 and disk-clamping member 30 are both formed from iron, the disk-clamping member 30 does not have to be fixed to the hub 3. That is, as described in FIG. 26, when the magnetic disk cartridge 2 is inserted in a disk drive unit, the magnet 7 mounted on the drive spindle 6 magnetically attracts the hub 3 and therefore the engagement portion 3d is engaged by the drive spindle 6. In this state, the drive spindle 6 spins the hub 3. Therefore, even in the case where the cylindrical portion 31 of the disk-clamping member 30 is loosely fitted in the center hole 3c of the hub 3, the disk-clamping member 30 is magnetically attracted and fixed to the hub 3 as the hub 3 is magnetically attracted.

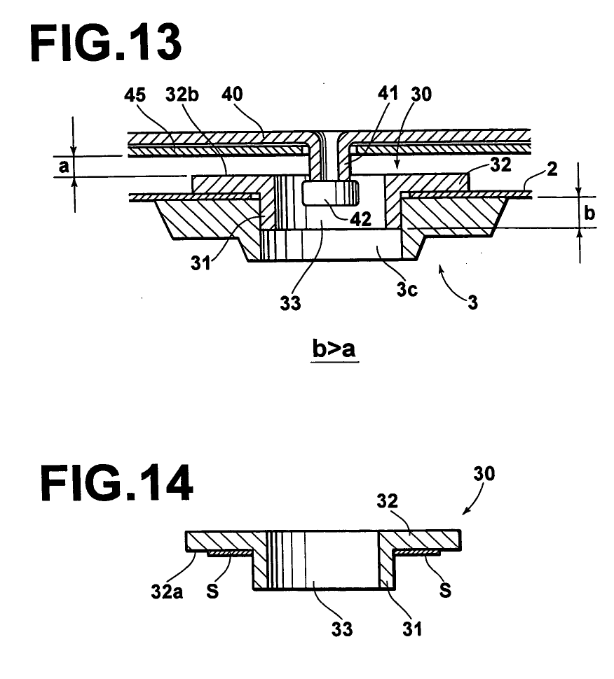

FIG. 13 shows the relative positional relationship between the rotating body of the small magnetic disk cartridge of the third invention of FIG. 9 (called the above-described “clik!(R)”) and other members.

This magnetic disk cartridge is equipped with a metal casing and a rotary shutter 45. The casing includes an upper shell 40 with a head slot (not shown) through which a read/write head is positioned over the upper side of the magnetic disk, and a lower shell (not shown) with a head slot through which a read/write head is positioned over the under side of the magnetic disk. When the magnetic disk cartridge is inserted in a disk drive unit (not shown), the rotary shutter 45 is rotated to an open position to expose the magnetic disk 2 through the head slots of the upper and lower shells. This shutter 45 is rotatably supported on a center shaft portion 41, which is formed to protrude toward the interior of the magnetic disk cartridge by performing burring on the metal sheet material of the upper shell 40. The tip end of the center shaft portion 41 is provided with an anti slip-out member 42 by welding so that the shutter 45 does not slip out from the center shaft portion 41, and the anti slip-out member 42 is disposed within the center hole 33 of the disk-clamping member 30.

In the state of FIG. 13 in which the cartridge is not inserted in a disk drive unit, reference character a represents the space between the top surface 32b of the flange portion 32 of the disk-clamping member 30 and the shutter 45, and reference character b represents the distance that the cylindrical portion 31 of the disk-clamping member 30 is inserted into the center hole 3c of the hub 3. If a condition of b>a is met, there is no possibility that the cylindrical portion 31 of the disk-clamping member 30 will slip out from the center hole 3c of the hub 3, even in the case where the cylindrical portion 31 of the disk-clamping member 30 is loosely fitted in the center hole 3c of the hub 3.

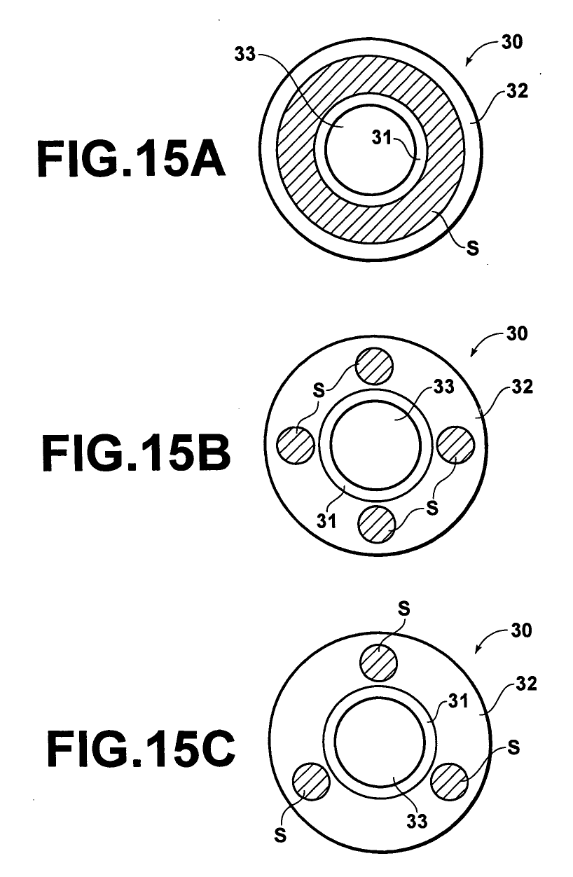

In the case where the disk-clamping member 30 alone cannot prevent the magnetic disk 2 from slipping on the hub 3, the bottom surface (press surface) 32a of the flange portion 32 may have a friction sheet S or a plurality of friction sheets S, as shown in FIG. 14 and FIGS. 15A to 15C. Preferable, the friction sheet S and friction sheets S are provided symmetrically with respect to the axis of rotation of the disk-clamping member 30.

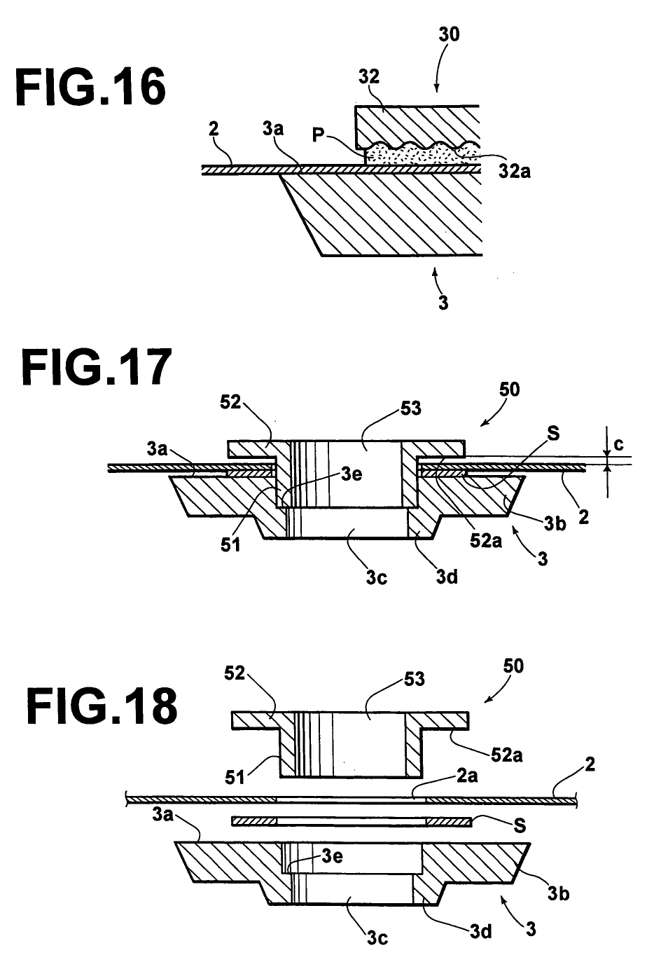

Instead of the friction sheet S, an elastic body P such as urethane foam may be interposed between the bottom surface (press surface) 32a of the flange portion 32 and the magnetic disk 2, as shown in FIG. 16. In this case, irregularities on the disk press surface 32a can be absorbed by the elastic body P, so when the disk-clamping member 30 is pressed against the magnetic disk 2, irregularities on the disk press surface 32a have little influence on the magnetic disk 2.

FIG. 17 shows the rotating body of a magnetic disk cartridge constructed in accordance with a fourth invention;

FIG. 18 shows an exploded sectional view of that rotating body.

In the figures, a flexible magnetic disk 2 and a hub 3 have center holes 2a and 3c, respectively. The hub 3 includes a disk portion 3b with a top surface 3a that serves as a disk-holding surface, and a small-diameter engagement portion 3d protruding from the bottom surface of the disk portion 3b.

The embodiment shown in FIGS. 17 and 18 is characterized in that the magnetic disk 2 is held on the disk-holding surface 3a of the hub 3 through the friction sheet S mounted on the disk-holding surface 3a, and a disk anti slip-out member 50 is employed. That is, the disk anti slip-out member 50 is equipped with a cylindrical portion 51, a flange portion 52 formed integrally with the cylindrical portion 51, and a center hole 53. The cylindrical portion 51 is fitted in the center hole 3c of the hub 3 through the center hole 2a of the magnetic disk 2.

The wall of the center hole 3c of the hub 3 is provided with a step portion 3e, which prescribes the depth that the cylindrical portion 51 of the disk anti slip-out member 50 is fitted in the center hole 3c. This provides slight clearance c (about 0.05 to 0.1 mm) between the bottom surface 52a of the flange portion 52 of the disk anti slip-out member 50 and the magnetic disk 2. The clearance c keeps the flange portion 52 of the disk anti slip-out member 50 from being pressed against the disk-holding surface 3a of the dish-holding plate 3, so the occurrence of residual stress in the magnetic disk 2 can be minimized.

In this case, if the drive spindle of the disk drive unit begins to rotate, torque is transmitted to the hub 3, and the hub 3 begins to rotate. Since the friction sheet S is mounted on the disk-holding surface 3a of the hub 3, friction force is produced between the surface of the friction sheet S and the surface of the magnetic disk 2, the magnetic disk 2 is firmly held on the friction sheet S. Therefore, even if clearance c is present between the bottom surface 52a of the flange portion 52 of the disk anti slip-out member 50 and the magnetic disk 2, the clearance c has no influence on read and write operations.

As with the aforementioned case, if the hub 3 and disk anti slip-out member 50 are both formed from iron, the disk anti slip-out member 50 does not need to be fixed to the hub 3. That is, as described in FIG. 26, when the magnetic disk cartridge 2 is inserted in a disk drive unit, the magnet 7 mounted on the drive spindle 6 magnetically attracts the hub 3 and therefore the engagement portion 3d is engaged by the drive spindle 6. In this state, the drive spindle 6 spins the hub 3. Therefore, even in the case where the cylindrical portion 51 of the disk anti slip-out member 50 is loosely fitted in the center hole 3c of the hub 3, the disk anti slip-out member 50 is magnetically attracted and fixed to the hub 3 as the hub 3 is magnetically attracted.

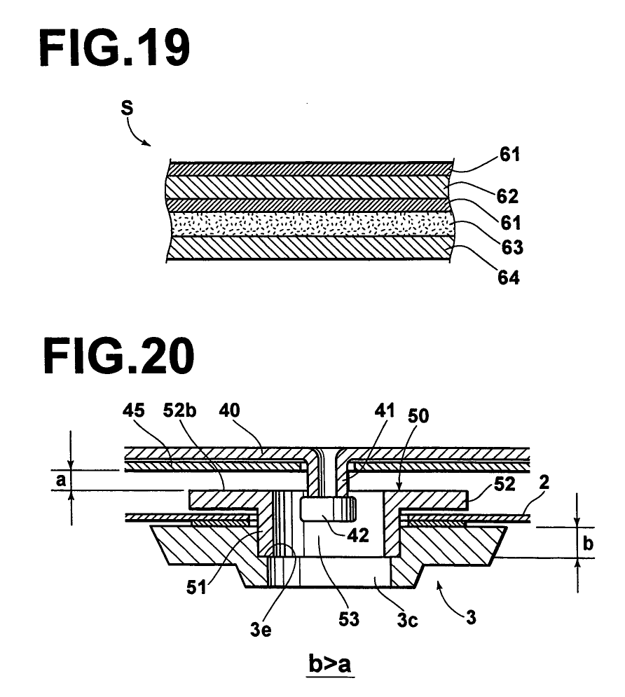

FIG. 19 depicts the construction of the friction sheet S. This friction sheet S is TSF570NK 0.15 AR75 (trade name), manufactured by Nikkan Kogyo. Both sides of a polyester support 62 of thickness 75 μm have acrylic films 61 of thickness 10 μg m, respectively. The lower acrylic film 61 is coated with acrylic adhesive 63 of thickness 55 μm, and the acrylic adhesive 63 is coated with silicon-processed release paper 64 of thickness 125 μm. The surface of the upper acrylic film 61 on which the magnetic disk 2 is placed has a static friction coefficient of 0.88.

FIG. 20 shows the relative positional relationship between the rotating body of the small magnetic disk cartridge of the third invention of FIG. 17 (called the above-described “clik!(R)”) and other members.

This magnetic disk cartridge is equipped with a metal casing and a rotary shutter 45. The casing includes an upper shell 40 with a head slot (not shown) through which a read/write head is positioned over the upper side of the magnetic disk, and a lower shell (not shown) with a head slot through which a read/write head is positioned over the under side of the magnetic disk. When the magnetic disk cartridge is inserted in a disk drive unit (not shown), the rotary shutter 45 is rotated to an open position to expose the magnetic disk 2 through the head slots of the upper and lower shells. This shutter 45 is rotatably supported on a center shaft portion 41, which is formed to protrude toward the interior of the magnetic disk cartridge by performing burring on the metal sheet material of the upper shell 40. The tip end of the center shaft portion 41 is provided with an anti slip-out member 42 by welding so that the shutter 45 does not slip out from the center shaft portion 41, and the anti slip-out member 42 is disposed within the center hole 53 of the disk anti slip-out member 50.

In the state of FIG. 20 in which the cartridge is not inserted in a disk drive unit, reference character a denotes the space between the top surface 52b of the flange portion 52 of the disk anti slip-out member 50 and the shutter 45, and reference character b denotes the distance that the cylindrical portion 51 of the disk anti slip-out member 50 is inserted into the center hole 3c of the hub 3. If a condition of b>a is met, there is no possibility that the cylindrical portion 51 of the disk anti slip-out member 50 will slip out from the center hole 3c of the hub 3, even in the case where the cylindrical portion 51 of the disk anti slip-out member 50 is loosely fitted in the center hole 3c of the hub 3.

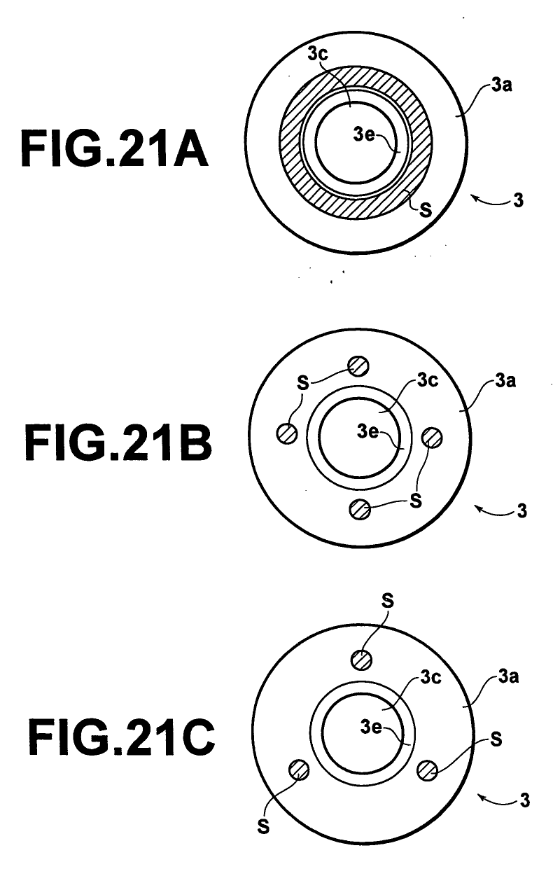

FIGS. 21A, 21B, and 21C show a friction sheet S and a plurality of friction sheets S, mounted on the disk-holding surface 3a of the hub 3. Preferably, the sheet S and sheets S are provided symmetrically with respect to the axis of rotation of the hub 3.

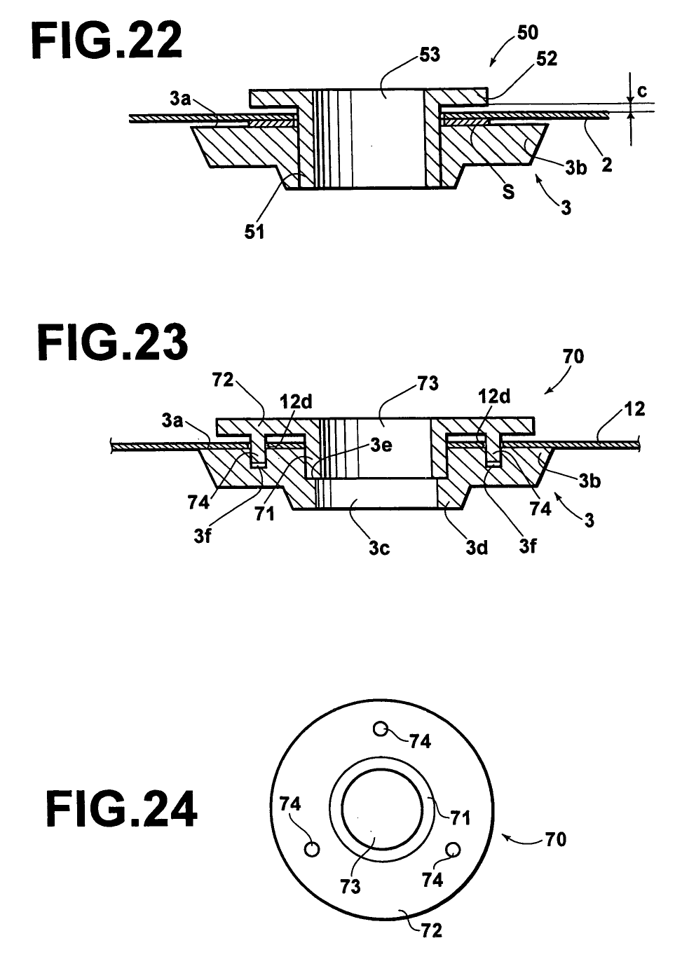

In the hub 3 shown in FIG. 17, the wall of the center hole 3c is provided with the step portion 3e that prescribes the insertion depth of the cylindrical portion 51 of the disk anti slip-out member 50 in order to provide a predetermined clearance c between the bottom surface 52a of the flange portion 52 of the disk anti slip-out member 50 and the magnetic disk 2. Instead of providing the step portion 3e, the cylindrical portion 51 of the disk anti slip-out member 50 may be lengthened as shown in FIG. 22 so that a desired clearance c is obtained when the cylindrical portion 51 is fitted in the center hole 3c of the hub 3. In that case, when the hub 3 is chucked by the drive spindle of a disk drive unit, the tip end face of the cylindrical portion 51 of the disk anti slip-out member 50 and the bottom surface of the hub 3 are supported by the flat top surface of the drive spindle. This makes the structure of the hub 3 simpler.

FIG. 23 shows the rotating body of a magnetic disk cartridge constructed in accordance with a fifth invention; FIG. 24 shows the bottom surface of the disk anti slip-out member shown in FIG. 23. This magnetic disk cartridge omits a friction sheet S by providing a disk rotation stopper in a disk anti slip-out member.

In FIG. 23, a disk anti slip-out member 70, as with the disk anti slip-out member 50, is equipped with a cylindrical portion 71 which is fitted in the center hole 3c of a hub 3, a flange portion 72 formed integrally with the cylindrical portion 71, and a center hole 73. In addition to these, the disk anti slip-out member 70 is equipped with anti slip-out protrusions 74, which extend from the bottom surface of the flange portion 72.

On the other hand, the wall of the center hole 3c of the hub 3, as with the hub shown in FIGS. 17 and 18, has a step portion 3e that prescribes the insertion depth of the cylindrical portion 71 of the disk anti slip-out member 70. This prevents the bottom surface of the flange portion 72 of the disk anti slip-out member 70 from making contact with the upper side of the magnetic disk 12.

The non-recording area of the central portion of the magnetic disk 12 is provided with guide holes 12d through which the anti slip-out protrusions 74 are passed. The disk-holding surface 3a of the hub 3 further has guide holes 3f in which the tip end portions of the anti slip-out protrusions 74 are fitted. Each guide hole 3f has a depth such that the tip end of the anti slip-out protrusion 74 does not reach the bottom of the hole 3f. Because of this, the insertion depth of the cylindrical portion 71 of the disk anti slip-out member 70 relative to the hub 3 is determined only by the step portion 3e of the center hole 3c of the hub 3.

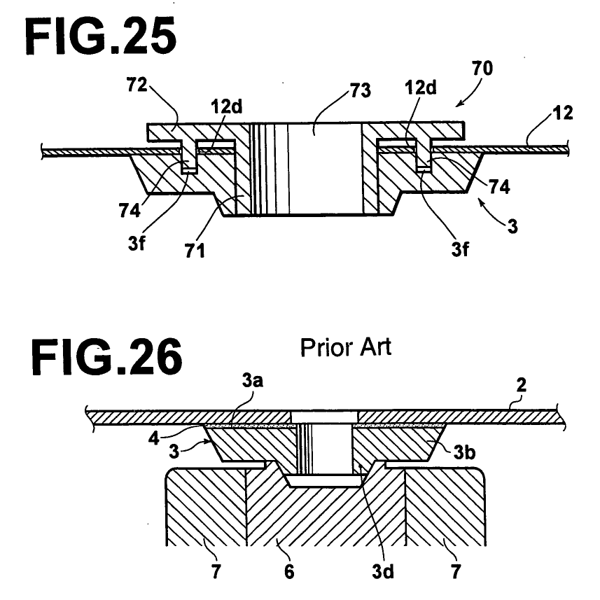

Instead of providing the step portion 3e that prescribes the insertion depth of the cylindrical portion 71 of the disk anti slip-out member 70, the cylindrical portion 71 of the disk anti slip-out member 70 may be lengthened as shown in FIG. 25. In this case, when the tip end face of the cylindrical portion 71 is coplanar with the bottom surface of the hub 3, the bottom surface of the flange portion 72 of the disk anti slip-out member 70 does not make contact with the upper side of the magnetic disk 12.

As with the aforementioned embodiments, if the hub 3 and disk anti slip-out member 70 are both formed from iron, the disk anti slip-out member 70 does not have to be fixed to the hub 3. That is, as described in FIG. 26, when the magnetic disk cartridge 2 is inserted in a disk drive unit, the magnet 7 mounted on the drive spindle 6 magnetically attracts the hub 3 and therefore the engagement portion 3d is engaged by the drive spindle 6. In this state, the drive spindle 6 spins the hub 3. Therefore, even in the case where the cylindrical portion 71 of the disk anti slip-out member 70 is loosely fitted in the center hole 3c of the hub 3, the disk anti slip-out member 70 is magnetically attracted and fixed to the hub 3 as the hub 3 is magnetically attracted.

Similarly, this embodiment prevents the occurrence of residual stress in the magnetic disk 12 and limits the movement of the magnetic disk 12 relative to the hub 3. Furthermore, since there is no projection on the disk-holding surface 3a of the hub 3 that contacts the magnetic disk 12, the polishing of the disk-holding surface 3a becomes easier in manufacturing the hub 3, and flatness is readily obtained.

While the present invention has been described with reference to the preferred embodiments thereof, the invention is not to be limited to the details given herein, but may be modified within the scope of the invention hereinafter claimed.

1-13. (canceled)

14. A magnetic disk cartridge comprising:
a flexible magnetic disk with a center hole;
a hub equipped with a center hole, and a disk-holding surface on which the central portion of said magnetic disk is held;
friction means which is provided on the disk-holding surface of said hub and through which said magnetic disk is held on said hub; and
a disk anti slip-out member comprising
a cylindrical portion which is fitted in the center hole of said hub through the center hole of said magnetic disk, and
a flange portion formed in one end of said cylindrical portion.

15. The magnetic disk cartridge as set forth in claim 14, wherein said friction means comprises a friction sheet mounted on the disk-holding surface of said hub.

16. The magnetic disk cartridge as set forth in claim 14, wherein said hub is formed from an iron material that can be attracted to a spindle of a disk drive unit by a magnet mounted on said spindle when said magnetic disk cartridge is inserted in said disk drive unit, and
said disk anti slip-out member is formed from an iron material that can be attracted to said hub as said hub is attracted to said drive spindle.

17. The magnetic disk cartridge as set forth in claim 14, wherein there is a predetermined clearance between said magnetic disk and the surface, facing said magnetic disk, of the flange portion of said disk anti slip-out member.

18. The magnetic disk cartridge as set forth in claim 17, wherein a wall of the center hole of said hub is provided with a step portion that prescribes an insertion depth of the cylindrical portion of said disk anti slip-out member relative to the center hole of said hub.

19-20. (canceled)
